(19) United States
(12) Patent Application Publication
(10) Pub. No.: US 2023/0183841 A1
(43) Pub. Date: Jun. 15, 2023

(54) ALUMINUM ALLOYS PRODUCED FROM RECYCLED ALUMINUM ALLOY SCRAP

(71) Applicant: Novelis Inc., Atlanta, GA (US)

(72) Inventors: Milan Felberbaum, Lausanne (CH); Guillaume Florey, Veyras (CH); Debdutta Roy, Marietta, GA (US); Rajeev G. Kamat, Marietta, GA (US); Peter Lloyd Redmond, Acworth, GA (US); Caitlin M. Aramburu, Kennesaw, GA (US)

(73) Assignee: Novelis Inc., Atlanta, GA (US)

(21) Appl. No.: 17/995,431

(22) PCT Filed: Apr. 14, 2021
(86) PCT No.: PCT/US2021/027256

§ 371 Date: Oct. 4, 2022

Related U.S. Application Data
(60) Provisional application No. 63/010,182, filed on Apr. 15, 2020.

(51) Int. Cl. C22C 21/08; C22F 1/047; C21D 8/02; C22B 21/00

(52) U.S. Cl. CPC C22C 21/08; C22F 1/047; C21D 8/0226; C21D 8/0236; C22B 21/0092

(57) ABSTRACT

Provided herein are aluminum alloys and methods of making these alloys. The aluminum alloys described herein are produced with a high content of recycled scrap. The recycled scrap may include used beverage can scrap and mixed alloy scrap (e.g., automotive scrap containing one or more of 5xxx, 6xxx, and/or 7xxx series aluminum alloys). Surprisingly, aluminum alloy products produced from the aluminum alloys including a high content of recycled scrap as described herein exhibit mechanical properties comparable to those displayed by high-performance aluminum alloy products, such as high tensile strength, good formability without cracking and/or fracture, and/or high elongation before fracture.

### CROSS-REFERENCE TO RELATED APPLICATION

This application claims the benefit of U.S. Provisional Application No. 63/010,182, filed Apr. 15, 2020, which is incorporated herein by reference in its entirety

### FIELD

The present disclosure relates to novel aluminum alloys, products made from these novel aluminum alloys, and methods of making these aluminum alloys and products. The aluminum alloys and products are suitable for a variety of applications, including automotive and electronics applications. The aluminum alloys are produced from a variety of sources of recycled aluminum alloy scrap and exhibit high strength and formability.

### BACKGROUND

There has long been an interest in using recycled aluminum alloy scrap for producing aluminum alloys. Incorporating recycled scrap leads to decreased cost and time associated with producing primary aluminum as well as decreased carbon emissions (e.g., decreased global impact). Recycled aluminum alloy scrap, however, may be unsuitable for use in preparing high performance aluminum alloys as the recycled aluminum alloy scrap may contain high levels of certain undesirable elements. The strict bounds on composition and processing for many high performance aluminum alloy products severely limit the amounts and types of recycled aluminum alloy scrap that can be used. For example, recycled scrap may include certain elements in amounts that adversely affect the mechanical properties of the aluminum alloys, such as formability and strength. For these reasons, it is impractical to use high amounts of recycled scrap for producing certain aluminum alloys, especially for automotive parts that require strictly controlled aluminum alloy compositions.

Additionally, there is a tradeoff based on the type of recycled aluminum alloy scrap used to produce aluminum alloys. Conventionally, recycled scrap from a metal casting facility (e.g., internal scrap or run-around scrap) or metalworking facility (e.g., segregated automotive scrap) may account for a majority of the recycled scrap content. For example, recycled scrap from a metal casting facility or metalworking facility may account for up to 95% of the recycled scrap content. The recycled scrap recovered from a metal casting facility or a metalworking facility (e.g., segregated automotive scrap) are high performance aluminum alloys that have consistent compositions and mechanical properties. Due to its consistency and properties, recycle scrap from these scrap sources is more expensive than other types of scrap (e.g., post-consumer scrap and mixed alloy scrap). In most recycle-friendly aluminum alloys, a substantial portion of the recycled scrap is from a metal casting facility or a metalworking facility, as post-consumer scrap may include higher amounts of impurities.

The use of recycled scrap from a metalworking facility is also limited because recycled scrap is typically provided as mixed aluminum alloy scrap (e.g., a mix of different aluminum alloys). In particular, recycled scrap from a metalworking facility is only used to produce aluminum alloys when the different alloy systems in the recycled scrap (e.g., 5xxx, 6xxx, or 7xxx series aluminum alloys) are properly separated. For example, recycled scrap from a metalworking facility can include a mix of 5xxx series aluminum alloys, 6xxx series aluminum alloys, and 7xxx series aluminum alloys that needs to be segregated before production of new aluminum alloys. Mixed alloys are considered to have very little value for producing new aluminum alloys without effective segregation of the mixed alloys. Therefore, mixed aluminum alloy scrap is rarely utilized as recycled scrap to produce aluminum alloys.

Aluminum alloys produced using recycled aluminum alloy scrap, especially those that must have material properties within certain specification limits, are either expensive in terms of time, space, and energy or require the use of significant amounts of new materials (e.g., primary aluminum) or high-purity aluminum scrap (e.g., segregated scrap from metal casting facilities or metal working facilities).

### SUMMARY

Covered embodiments of the invention are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

Provided herein are new aluminum alloys and aluminum alloy products and methods of making these aluminum alloys and products. In some embodiments, the aluminum alloy comprises 0.50 wt. %-3.00 wt. % Mg, 0.10 wt. %-3.50 wt. % Si, 0.01 wt. %-0.60 wt. % Fe, up to 1.20 wt. % Cu, 0.10 wt. %-0.90 wt. % Mn, up to 0.20 wt. % Cr, up to 0.20 wt. % Ti, up to 0.10 wt. % V, up to 1.00 wt. % Zn, up to 0.15 wt. % impurities, and Al. In some aspects, the aluminum alloy comprises 1.00 wt. %-2.50 wt. % Mg, 0.20 wt. %-3.00 wt. % Si, 0.15 wt. %-0.50 wt. % Fe, 0.001 wt. %-0.90 wt. % wt. % Cu, 0.20 wt. %-0.80 wt. % Mn, up to 0.15 wt. % Cr, up to 0.10 wt. % Ti, up to 0.08 wt. % V, 0.001 wt. %-0.50 wt. % Zn, up to 0.15 wt. % impurities, and Al. In some aspects, the aluminum alloy comprises 1.40 wt. %-2.40 wt. % Mg, 0.30 wt. %-2.50 wt. % Si, 0.20 wt. %-0.40 wt. % Fe, 0.05 wt. %-0.75 wt. % Cu, 0.40 wt. %-0.70 wt. % Mn, up to 0.10 wt. % Cr, up to 0.05 wt. % Ti, up to 0.05 wt. % V, 0.005 wt. %-0.40 wt. % Zn, up to 0.15 wt. % impurities, and Al. In some aspects, the aluminum alloy comprises 1.00 wt. %-3.00 wt. % Mg, 0.10 wt. %-0.90 wt. % Si, 0.01 wt. %-0.60 wt. % Fe, up to 0.50 wt. % Cu, 0.10 wt. %-0.90 wt. % Mn, up to 0.20 wt. % Cr, up to 0.20 wt. % Ti, up to 0.10 wt. % V, up to 1.00 wt. % Zn, up to 0.15 wt. % impurities, and Al; wherein the aluminum alloy comprises up to 100% recycled scrap; and wherein the recycled scrap comprises at least 25% of used beverage can scrap, based on the total weight of the recycled scrap. In some aspects, the aluminum alloy comprises 1.25 wt. %-2.50 wt. % Mg, 0.20 wt. %-0.80 wt. % Si, 0.15 wt. %-0.50 wt. % Fe, 0.01 wt. %-0.30 wt. % Cu, 0.20 wt. %-0.80 wt. % Mn, up to 0.15 wt. % Cr, up to 0.10 wt. % Ti, up to 0.05 wt. % V, up to 0.50 wt. % Zn, up to 0.15 wt. % impurities, and Al. In some aspects, the aluminum alloy comprises 1.60 wt. %-2.40 wt. % Mg, 0.30 wt. %-0.60 wt. % Si, 0.20 wt. %-0.40 wt. % Fe, 0.05 wt. %-0.20 wt. % Cu, 0.40 wt. %-0.70 wt. % Mn, up to 0.10 wt. % Cr, up to 0.05 wt. % Ti, up to 0.03 wt. % V, up to 0.20 wt. % Zn, up to 0.15 wt. % impurities, and Al. In some aspects, a ratio of the wt. % of Si:Mg is from 0.05:1 to 0.60:1. In some aspects, the aluminum alloy has an excess Si content from −1.70 to 0.10. In some aspects, the aluminum alloy comprises a Cu content of less than 0.20 wt. %, a Si:Mg ratio from 0.20:1 to 0.45:1, and an excess Si content from −1.30 to 0. In some aspects, the recycled scrap comprises at least 50% of used beverage can scrap, based on the total weight of the recycled scrap. In some aspects, the recycled scrap comprises at least 25% of mixed alloy scrap. In some aspects, the mixed alloy scrap comprises one or more of a 5xxx series aluminum alloy, a 6xxx series aluminum alloy, and a 7xxx series aluminum alloy. In some aspects, the mixed alloy scrap comprises a ratio of the 5xxx series aluminum alloy to the 6xxx series aluminum alloy from 1:3 to 3:1. In some aspects, the mixed alloy scrap comprises at least 18.75 wt. % of the 5xxx series aluminum alloy, based on the total weight of the recycled scrap. In some aspects, the mixed alloy scrap comprises at least 18.75 wt. % of 6xxx series aluminum alloy, based on the total weight of the recycled scrap. In some aspects, the aluminum alloy, when in a T4 temper, has a yield strength (Rp0.2) of from 160 MPa to 250 MPa when tested according to ISO 6892-1 (2016) after paint baking at a temperature of about 185° C. for about 20 minutes and 2% pre-straining. In some aspects, the aluminum alloy has a total elongation of at least 15%. In some aspects, the aluminum alloy has a r(10) value of at least 0.40 in all directions (longitudinal (L), diagonal (D), and/or transverse (T) to a rolling direction). In some aspects, the aluminum alloy has a R bend angle of from 40° to 100° for bendability testing according to Specification VDA 238-100. In some aspects, the aluminum alloy excludes any primary aluminum alloy. In some aspects, the aluminum alloy is a sheet, a plate, an electronic device housing, an automotive structural part, an aerospace structural part, an aerospace non-structural part, a marine structural part, or a marine non-structural part. In some aspects, the aluminum alloy is produced from a process comprising homogenization, hot rolling, cold rolling, solution heat treatment, pre-aging, and artificial aging. In some aspects, the aluminum alloy is cool coiled after hot rolling. In some aspects, the aluminum alloy comprises at least 75% recycled scrap. In some aspects, the aluminum alloy comprises recycled scrap from one or more of end-of life aluminum articles, mixed automotive scrap, UBC scrap, twitch, and heat exchanger scrap. In some aspects, the recycled scrap comprises the end-of life aluminum articles and wherein the end-of life aluminum articles are derived from aluminum-intensive vehicles. In some aspects, the recycled scrap comprises 100% of scrap derived from the end-of life aluminum articles. In some aspects, the recycled scrap comprises the heat exchanger scrap and wherein the heat exchanger scrap comprises braze alloy scrap. In some aspects, the recycle scrap comprises the mixed automotive scrap and the mixed automotive scrap comprises recycled scrap from wrought alloys and cast alloys. In some aspects, the aluminum alloy comprises up to 25% primary aluminum alloy.

Other objects and advantages will be apparent from the following detailed description of non-limiting examples.

### BRIEF DESCRIPTION OF THE FIGURES

FIG. 1 is a graph of the solvus and solidus temperatures (° C.) for the aluminum alloy samples described herein.

FIG. 2 is a graph of the solidus temperature (° C.) as a function of the wt. % of recycled scrap in the aluminum alloy samples described herein.

FIGS. 3a-c are graphs of the ultimate tensile strength (Rm) and yield strength (Rp0.2) (both measured in MPa) for aluminum samples after batch annealing (e.g., after batch annealing for 2 hours at 330° C.; FIG. 3a), continuous annealing and solution heat treatment at 550° C. for 0 seconds (FIG. 3b), and continuous annealing and solution heat treatment at 550° C. for 60 seconds (FIG. 3c).

FIGS. 4a-c are graphs of total elongation (A80) and uniform elongation (Ag) (both measured in %) for aluminum samples after batch annealing (e.g., after batch annealing for 2 hours at 330° C.; FIG. 4a), continuous annealing and solution heat treatment at 550° C. for 0 seconds (FIG. 4b), and continuous annealing and solution heat treatment at 550° C. for 60 seconds (FIG. 4c).

FIGS. 5a-c are graphs showing r(8-12) values and n(10-15) values for aluminum alloy samples after batch annealing (e.g., after batch annealing for 2 hours at 330° C.; FIG. 5a), continuous annealing and solution heat treatment at 550° C. for 0 seconds (FIG. 5b), and continuous annealing and solution heat treatment at 550° C. for 60 seconds (FIG. 5c).

FIGS. 6a-c are graphs showing R bend angle values according to Specification VDA 238-100 (measured in degrees (°)) and n(10-20) values for aluminum alloy samples after batch annealing (e.g., after batch annealing for 2 hours at 330° C.; FIG. 6a), continuous annealing and solution heat treatment at 550° C. for 0 seconds (FIG. 6b), and continuous annealing and solution heat treatment at 550° C. for 60 seconds (FIG. 6c).

FIGS. 7a-c are graphs of the yield strength (Rp0.2) for aluminum alloy samples in a T8x temper (y-axis) (e.g., Rp0.2 after thermal treatment at a temperature of about 185° C. for about 20 minutes after 2% pre-straining) and a T4 temper (x-axis) (both measured in MPa) after batch annealing (e.g., after batch annealing for 2 hours at 330° C.; FIG. 7a), continuous annealing and solution heat treatment at 550° C. for 0 seconds (FIG. 7b), and continuous annealing and solution heat treatment at 550° C. for 60 seconds (FIG. 7c).

FIGS. 8a-c are graphs showing R bend angle values according to Specification VDA 238-100 (measured in degrees (°)) and yield strength (Rp0.2) (measured in MPa) for aluminum alloy samples in a T8x temper (e.g., Rp0.2 after thermal treatment at a temperature of about 185° C. for about 20 minutes after 2% pre-straining) after batch annealing (e.g., after batch annealing for 2 hours at 330° C.; FIG. 8a), continuous annealing and solution heat treatment at 550° C. for 0 seconds (FIG. 8b), and continuous annealing and solution heat treatment at 550° C. for 60 seconds (FIG. 8c).

FIGS. 9a-c are graphs of uniform elongation (Ag) (measured in %) as a function of the wt. % UBC used to produce the aluminum alloy samples after batch annealing (e.g., after batch annealing for 2 hours at 330° C.; FIG. 9a), continuous annealing and solution heat treatment at 550° C. for 0 seconds (FIG. 9b), and continuous annealing and solution heat treatment at 550° C. for 60 seconds (FIG. 9c).

FIG. 10a-c are graphs showing r(8-12) values as a function of the wt. % UBC used to produce the aluminum alloy samples after batch annealing (e.g., after batch annealing for 2 hours at 330° C.; FIG. 10a), continuous annealing and solution heat treatment at 550° C. for 0 seconds (FIG. 10b), and continuous annealing and solution heat treatment at 550° C. for 60 seconds (FIG. 10c).

FIG. 11 is a graph of uniform elongation (Ag) (measured in %) for aluminum alloy samples as a function of the Si+Mn—(Fe/2) content in the aluminum alloy composition.

FIG. 12 is a graph of yield strength (Rp0.2) for aluminum alloy samples in a T8x temper (y-axis) (e.g., Rp0.2 after thermal treatment at a temperature of about 185° C. for about 20 minutes after 2% pre-straining) as a function of the Si+Mn—(Fe/2) content in the aluminum alloy composition.

FIG. 13 is a graph of yield strength (Rp0.2) for aluminum alloy samples in a T8x temper (y-axis) (e.g., Rp0.2 after thermal treatment at a temperature of about 185° C. for about 20 minutes after 2% pre-straining) and a T4 temper (x-axis) (both measured in MPa) for aluminum samples after continuous annealing and solution heat treatment at 550° C. for 60 seconds.

FIG. 14 is a graph of total elongation (A80) and uniform elongation (Ag) (both measured in %) for aluminum samples after continuous annealing and solution heat treatment at 550° C. for 60 seconds.

FIG. 15 is a graph showing n(4-6) values and n(10-20) values for aluminum alloy samples after continuous annealing and solution heat treatment at 550° C. for 60 seconds.

### DETAILED DESCRIPTION

Described herein are aluminum alloys prepared from recycled aluminum alloy scrap (also referred to herein as “recycled scrap”). Recycled scrap can be used to prepare aluminum alloys having mechanical properties (e.g., strength and formability) suitable for use in a variety of applications, such as automotive applications (e.g., hood inners) and household products (e.g., cookware, including pots and pans). Aluminum alloys can be produced from recycled scrap collected from various sources and maintain desirable properties, such as desirable mechanical properties. Surprisingly, the aluminum alloy products produced from aluminum alloys including a high content of recycled scrap as described herein exhibit mechanical properties comparable to those displayed by high-performance aluminum alloy products, such as high tensile strength, good formability without cracking and/or fracture, and/or high elongation before fracture.

The aluminum alloys described herein are produced with a high content of recycled scrap. In some embodiments, the recycled scrap may include at least 25% of used beverage can (UBC) scrap and/or mixed alloy scrap (e.g., automotive scrap containing one or more of 5xxx, 6xxx, and/or 7xxx series aluminum alloys). Conventionally, existing aluminum alloys, particularly for automotive applications, are only produced using standard automotive scrap, run-around scrap, primary aluminum, and additional alloying elements (e.g., Si, Cu, Mn, and Mg). This is because using UBC scrap and mixed alloy scrap is difficult to re-melt in standard aluminum alloys for automotive parts with controlled compositions that achieve specific mechanical properties. As described herein, using a high amount of UBC scrap, in combination with mixed alloy scrap, can achieve desirable mechanical properties (e.g., tensile strength, formability, elongation before fracture, etc.), while using very low-cost recycled scrap in an environmentally-friendly process. The new aluminum alloys described herein are produced from very low-cost recycled scrap materials and achieve comparable properties to other aluminum alloys for automotive parts.

In some embodiments, the aluminum alloys described herein are produced from 100% recycled scrap. That is, there is no primary aluminum included in the aluminum alloy which results in a significant cost savings, and has a much lower impact on the environment as producing primary aluminum has significant energy expenditures. The aluminum alloy may be produced from a combination of UBC scrap and mixed alloy scrap. Unexpectedly, the aluminum alloys produced from these recycled scrap materials exhibit both high strength and formability for use in automotive applications. The aluminum alloys described herein also demonstrate good tensile properties, bendability, and elongation.

In some embodiments, the aluminum alloys described herein are produced from mixed alloy scrap comprising one or more of end-of-life (EOL) aluminum articles (e.g., aluminum-intensive vehicles), unsegregated automotive scrap (e.g., containing one or more of 5xxx, 6xxx, and/or 7xxx series aluminum alloys from wrought and cast alloys), twitch, and recycled aluminum alloy parts (e.g., a heat exchanger, braze alloy scrap, etc.). The mixed alloy scrap is very low cost and using mixed alloy scrap to produce aluminum alloys can provide a significant cost reduction and reduce overall carbon emissions. As described herein, using these recycled aluminum alloy materials can achieve desirable mechanical properties, while using very low-cost recycled scrap.

The high formability can be measured, for example, by measuring total elongation or uniform elongation. ISO/EN A80 is one appropriate standard that can be used for testing the total elongation (EN 10002 parts 1-5, (2001)). ISO/EN Ag is one appropriate standard that can be used for testing the uniform elongation. For example, the aluminum alloys as described can have a total elongation (A80) of at least 15% (e.g., from 15% to 30%). In some examples, the aluminum alloys as described can have a uniform elongation (Ag) of at least 15% (e.g., from 15% to 22%). The total elongation and uniform elongation are taken as the mathematical average of the elongation in the longitudinal (L), diagonal (D), and transverse (T) directions.

Another way to measure formability is by determining the r-value (also known as the Lankford coefficient), the plastic strain ratio during a tensile test. The r-value is a measurement of the deep-drawability of a sheet metal (i.e., the resistance of a material to thinning or thickening when put into tension or compression). The r-value can be measured according to ISO 10113 (2006) or according to ASTM E517 (2019), for example. The r-value measured over a strain range from 8% to 12% is indicated as r(8-12). For instance, the aluminum alloys as described can have an r(8-12) value of at least 0.50 (e.g., from 0.50 to 0.80).

The n-value, or the strain-hardening exponent, gives an indication of how much the material hardens or becomes stronger when plastically deformed. The n-value can be measured using ISO 10275 (2007) or according to ASTM E646 (2016). The n-value measured over a strain range from 10% to 15% is indicated as n(10-15). For instance, the aluminum alloys as described can have an n(10-15) value of at least about 0.18 (e.g., from about 0.18 to about 0.28).

In addition to these performance characteristics, the recycled scrap used to produce the aluminum alloys described herein surprisingly require little or no primary aluminum materials. For example, mixed alloy scrap resulting from a scrapped and shredded aluminum body structure from an aluminum intensive vehicle (“AIV”) is suitable for making new aluminum alloys without requiring significant dilution with primary 5xxx series aluminum alloy and/or primary 6xxx series aluminum alloy. Additionally, unsegregated automotive scrap (e.g., wrought and cast alloys), heat exchanger scrap, and brazing alloy scrap can be utilized to produce the aluminum alloys described herein. In some embodiments, the EOL aluminum articles can be recycled scrap materials derived from AIVs. The recycled scrap from EOL aluminum articles can be used in combination with different scrap streams including, but not limited to, twitch, mixed automotive scrap, braze alloy scrap, and UBC scrap, to produce aluminum alloys having good mechanical properties.

Surprisingly, the aluminum alloys as described herein are produced from low-cost recycled scrap and still exhibit high strength (e.g., after paint baking) and high formability.

### Definitions and Descriptions

As used herein, the terms “invention,” “the invention,” “this invention,” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by AA numbers and other related designations, such as “series” or “5xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than 15 mm, greater than 20 mm, greater than 25 mm, greater than 30 mm, greater than 35 mm, greater than 40 mm, greater than 45 mm, greater than 50 mm, or greater than 100 mm.

As used herein, a shate (also referred to as a sheet plate) generally has a thickness of from about 4 mm to about 15 mm. For example, a shate may have a thickness of 4 mm, 5 mm, 6 mm, 7 mm, 8 mm, 9 mm, 10 mm, 11 mm, 12 mm, 13 mm, 14 mm, or 15 mm.

As used herein, a sheet generally refers to an aluminum product having a thickness of less than about 4 mm. For example, a sheet may have a thickness of less than 4 mm, less than 3 mm, less than 2 mm, less than 1 mm, less than 0.5 mm, less than 0.3 mm, or less than 0.1 mm.

Reference is made in this application to alloy temper or condition. For an understanding of the alloy temper descriptions most commonly used, see “American National Standards (ANSI) H35 on Alloy and Temper Designation Systems.” An F condition or temper refers to an aluminum alloy as fabricated. A W condition or temper refers to an aluminum alloy solution heat treated at a temperature greater than a solvus temperature of the aluminum alloy and then quenched. An O condition or temper refers to an aluminum alloy after annealing. An Hxx condition or temper, also referred to herein as an H temper, refers to a non-heat treatable aluminum alloy after cold rolling with or without thermal treatment (e.g., annealing). Suitable H tempers include HX1, HX2, HX3 HX4, HX5, HX6, HX7, HX8, or HX9 tempers. A T1 condition or temper refers to an aluminum alloy cooled from hot working and naturally aged (e.g., at room temperature). A T2 condition or temper refers to an aluminum alloy cooled from hot working, cold worked and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or anywhere in between. For example, barometric pressure can be about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. The term “about” includes the exact value.

As used herein, the meaning of “a,” “an,” and “the” includes singular and plural references unless the context clearly dictates otherwise.

As used herein, the term recycled scrap can refer to a collection of recycled metal. Recycled scrap can include materials recycled from any suitable source, such as from a metal production facility (e.g., a metal casting facility), from a metalworking facility (e.g., a production facility that uses metal products to create consumable products), or from post-consumer sources (e.g., regional recycling facilities).

As used herein, used beverage cans (UBC) refers to any used beverage can scrap known in the art, for example those described in the Scrap Specifications Circular (2018) published by the Institute of Scrap Recycling Industries, Inc., including shredded aluminum UBC scrap, densified aluminum UBC scrap, baled aluminum UBC scrap, and/or briqueted aluminum UBC scrap.

As used herein, “twitch” refers to any fragmented aluminum scrap. Twitch may be produced by a float process whereby the scrap is immersed in water. The aluminum scrap floats to the top and heavier metal scrap pieces sink. For example, in some processes, sand may be mixed in to change the density of the water in which the scrap is immersed.

As used herein, “aluminum-intensive vehicles” (AIV) refers to vehicles comprising a substantial portion of aluminum alloy.

Throughout the application, the aluminum alloys and aluminum alloy products and their components are described in terms of their elemental composition in weight percent (wt. %). In some aspects, the remainder for the alloy is aluminum, with a maximum wt. % of 0.50% for the sum of all impurities (e.g., a maximum of 0.45 wt. %, a maximum of 0.40 wt. %, a maximum of 0.35 wt. %, a maximum of 0.30 wt. %, a maximum of 0.25 wt. %, a maximum of 0.20 wt. %, a maximum of 0.15 wt. %, and/or a maximum of 0.10 wt. %).

### Recycled Content Alloys

The aluminum alloys described herein can be produced entirely from recycled scrap (e.g., 100% recycled scrap). In some embodiments, the aluminum alloys described herein can be produced from a combination of different recycled scrap materials. Recycled aluminum alloy scrap (e.g., recycled scrap) can be obtained from various sources at all stages of the aluminum life cycle. In some cases, recycled scrap can refer to a collection of recycled metal. Recycled scrap can include materials recycled from any suitable source, such as from a metal production facility (e.g., a metal casting facility), from a metalworking facility (e.g., a production facility that uses metal products to create consumable products), or from post-consumer sources (e.g., regional recycling facilities). For example, internal scrap may be produced during production of an aluminum alloy in a metal casting facility (e.g., scrap from producing an aluminum ingot, billet, sheet, plate, etc.), customer scrap may be produced during stamping, milling, and other processes in a metalworking facility (e.g., scrap from creating can bodies, can ends, automobile parts, etc.), and post-consumer scrap may be produced from aluminum products used by consumers and collected at regional recycling facilities (e.g., used beverage cans, used automobile parts, etc.). Each of these types of recycled scrap can be a substitute for primary aluminum metal.

The aluminum alloys described herein can tolerate higher amounts of post-consumer scrap and mixed alloy scrap and still exhibit desirable mechanical properties. The impact of the impurities and/or alloying elements on the mechanical properties of the aluminum alloy is reduced by providing a specific mixture of recycled scrap to compensate for the impurities. This enables a higher amount of less expensive, higher impurity aluminum scrap (e.g., post-consumer scrap and mixed alloy scrap) for producing aluminum alloys that can still exhibit desirable properties. The aluminum alloy compositions described herein can include higher amounts of post-consumer scrap and mixed alloy scrap with little or no additional primary aluminum and a reduced amount of more expensive recycled scrap (e.g., segregated scrap from a metal casting facility).

Adding primary aluminum reduces the amount of recycled content and raises costs, as primary aluminum is more expensive to produce than recycled scrap. Therefore, a tradeoff is often made between limiting the amount of recycled scrap and adding primary aluminum to achieve specific mechanical properties. Moreover, producing primary aluminum alloy results in significant carbon emissions in comparison to re-purposing recycled scrap to produce new aluminum alloys.

Additionally, there is a tradeoff based on the type of recycled scrap used to produce aluminum alloys. Conventionally, segregated recycled scrap from a metal casting facility (e.g., internal scrap or run-around scrap) or a metalworking facility (e.g., automotive scrap) may account for a majority of the recycled scrap content. However, mixed alloy scrap from a metalworking facility is only used to produce aluminum alloys when the different alloy systems in the recycled scrap (e.g., 5xxx or 6xxx series aluminum alloys) are properly separated. Mixed alloys have very little value for producing new aluminum alloys without effective segregation of the mixed alloys. Therefore, where recycled scrap is used to produce aluminum alloys, only up to 5% of the material is post-consumer scrap or mixed alloy scrap, with the remainder being other types of recycled aluminum alloy materials (e.g., internal scrap, runaround scrap, or segregated scrap, etc.). Post-consumer scrap and mixed alloy can include impurities and specific alloying elements (e.g., high contents of Cu, Fe, or Mn) that make it difficult to control the composition of the aluminum alloy.

Certain aspects of the present disclosure can be well-suited for using a combination of post-consumer scrap (e.g., UBC scrap) and mixed alloy scrap to produce aluminum alloys. Post-consumer scrap can include recycled aluminum, such as recycled sheet aluminum products (e.g., aluminum pots and pans), recycled cast aluminum products (e.g., aluminum grills and wheel rims), used beverage can (“UBC”) scrap, aluminum wire, end-of-life aluminum alloy products (e.g., aluminum-intensive vehicles, heat exchangers, etc.) and other aluminum materials.

The aluminum alloy compositions described herein can include higher amounts of post-consumer scrap (e.g., UBC) and mixed alloy scrap with little or no additional primary aluminum and a reduced amount of more expensive recycled scrap (e.g., segregated recycled scrap from a metal casting facility or a metalworking facility). For example, an aluminum alloy may be produced from recycled scrap comprising at least 25% post-consumer scrap (e.g., from 25% to 100%, from 30% to 100%, from 40% to 100%, from 50% to 100%, from 60% to 100%, or from 75% to 100% post-consumer scrap). For example, the aluminum alloy can include greater than 25% post-consumer scrap, e.g., greater than 30%, greater than 35%, greater than 40% greater than 45% greater than 50%, greater than 55%, greater than 60% greater than 65% greater than 70%, or greater than 75% post-consumer scrap. All are expressed in wt. %. The high content of post-consumer scrap results in a significant cost savings and can produce a 100% recycle-based aluminum alloy.

In some aspects, the aluminum alloys described herein include a high amount of UBC scrap at or greater than 25% UBC, e.g., at or greater than 30%, at or greater than 35%, at or greater than 40% at or greater than 45% at or greater than 50%, at or greater than 55%, at or greater than 60% at or greater than 65% at or greater than 70%, or at or greater than 75%. In terms of ranges, the aluminum alloys described herein can include from 25% to 100% UBC scrap (e.g., from 25% to 100%, from 30% to 100%, from 40% to 100%, from 50% to 100% from 60% to 100%, or from 75% to 100%).

In some aspects, UBC scrap is a mixture of various aluminum alloys (e.g., from different aluminum alloys used for can bodies and can ends) and can often include foreign substances, such as rainwater, drink remainders, organic matter (e.g., paints and laminated films), and other materials. UBC scrap generally includes a mixture of metal from various aluminum alloys, such as metal from can bodies (e.g., 3104, 3004, or other 3xxx series aluminum alloys) and can ends (e.g., 5182 or other 5xxx series aluminum alloys). UBC scrap can be shredded and decoated or delacquered prior to being melted for use as liquid metal stock in casting a new metal product.

In some embodiments, the aluminum alloys described herein can include mixed alloy scrap. In some embodiments, the mixed alloy scrap includes mixed automotive scrap. In some embodiments, the mixed alloy scrap includes recycle scrap from end-of-life aluminum alloy products (e.g., aluminum-intensive vehicles, heat exchangers, etc.). The mixed alloy scrap can be derived from wrought alloys, cast alloys, and extrusion alloys. For example, the aluminum alloy can be produced from mixed alloy scrap comprising 5xxx series aluminum alloy scrap. As another example, the aluminum alloy can be produced from mixed alloy scrap comprising 6xxx series aluminum alloy. As yet another example, the aluminum alloy can be produced from mixed alloy scrap comprising 7xxx series aluminum alloy. In another example, the aluminum alloy can be produced from mixed alloy scrap comprising 5xxx series aluminum alloy scrap, 6xxx series aluminum alloy scrap, and 7xxx series aluminum alloy scrap. In some cases, the 5xxx series aluminum alloy is the predominant alloy in the mixed alloy scrap. In other cases, the 6xxx series aluminum alloy is the predominant alloy in the mixed alloy scrap. In other cases, the 7xxx series aluminum alloy is the predominant alloy in the mixed alloy scrap. In some cases, the 5xxx 6xxx, and 7xxx series aluminum alloys are present in equal amounts in the mixed alloy scrap. In some aspects, the aluminum alloy can be produced from recycled scrap including from 0% to 75% mixed alloy scrap (e.g., from 5% to 70%, from 10% to 65%, from 15% to 60%, from 20% to 50%, or from 25% to 40% mixed alloy scrap), based on the total weight of the recycled scrap. For example, the aluminum alloy can be produced from recycled scrap including greater than 0% mixed alloy scrap (e.g., greater than 1%, greater than 5%, greater than 10%, greater than 15%, greater than 20%, or greater than 25%) based on the total weight of the recycled scrap. All are expressed in wt. %.

As discussed above, in some aspects the recycled scrap includes a mixed alloy scrap including two or more of 5xxx series aluminum alloy scrap, 6xxx series aluminum alloy scrap, and 7xxx series aluminum alloy scrap. In some aspects, the recycled scrap can include a 5xxx series aluminum alloy scrap (from the mixed alloy scrap) in an amount from 0% to 75% (e.g., from 5% to 70%, from 10% to 65%, from 15% to 60%, from 20% to 50%, or from 25% to 40%), based on the total weight of the recycled scrap. For example, the recycled scrap can include greater than 0% of a 5xxx series aluminum alloy scrap (e.g., greater than 1%, greater than 5%, greater than 10%, greater than 15%, greater than 20%, or greater than 25%), based on the total weight of the recycled scrap. All are expressed in wt. %.

In some aspects, the recycled scrap can include a 6xxx series aluminum alloy scrap (from the mixed alloy scrap) in an amount from 0% to 75% (e.g., from 5% to 70%, from 10% to 65%, from 15% to 60%, from 20% to 50%, or from 25% to 40%), based on the total weight of the recycled scrap. For example, the recycled scrap can include greater than 0% of a 6xxx series aluminum alloy scrap (e.g., greater than 1% greater than 5%, greater than 10%, greater than 15%, greater than 20%, or greater than 25%), based on the total weight of the recycled scrap. All are expressed in wt. %.

In some aspects, the recycled scrap can include a 7xxx series aluminum alloy scrap (from the mixed alloy scrap) in an amount from 0% to 75% (e.g., from 5% to 70%, from 10% to 65%, from 15% to 60%, from 20% to 50%, or from 25% to 40%), based on the total weight of the recycled scrap. For example, the recycled scrap can include greater than 0% of a 7xxx series aluminum alloy scrap (e.g., greater than 1% greater than 5%, greater than 10%, greater than 15%, greater than 20%, or greater than 25%), based on the total weight of the recycled scrap. All are expressed in wt. %.

In some examples, suitable 5xxx series aluminum alloys for use in the aluminum alloys described herein include, for example, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, and AA5088.

In some examples, suitable 6xxx series aluminum alloys for use in the aluminum alloys described herein include, for example, AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, and AA6092.

Suitable 7xxx series aluminum alloys for use in the aluminum alloys described herein include, for example, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, and AA7099.

In some embodiments, the mixed alloy scrap may comprise recycled scrap derived from EOL aluminum alloy articles. In some embodiments, the recycled scrap derived from EOL aluminum alloy articles may include multiple series of aluminum alloys. For example, the recycled scrap derived from EOL aluminum alloy articles may include 5xxx series aluminum alloy scrap, 6xxx series aluminum alloy scrap, and/or 7xxx series aluminum alloy scrap from wrought or cast aluminum alloys. In some embodiments, the mixed alloy scrap may comprise EOL aluminum alloy articles, unsegregated automotive scrap, twitch, braze alloy scrap, and/or UBC.

In some embodiments, the recycled scrap may include scrap derived from EOL aluminum alloy articles, mixed automotive scrap, twitch, heat-exchanger scrap, braze alloy scrap, UBC scrap, or combinations thereof. In some embodiments, EOL aluminum articles may include aluminum-intensive vehicles. Recycled scrap derived from aluminum-intensive vehicles may include one or more of 5xxx series aluminum alloys, 6xxx series aluminum alloys, and 7xxx series aluminum alloys from cast and extrusion alloys. Recycled scrap derived from twitch may include one or more of cast aluminum alloys and wrought aluminum alloys. Recycled scrap derived from heat exchangers may include 3xxx series aluminum alloys and 4xxx series aluminum alloys.

In some embodiments, the recycled scrap may include up to 100% EOL aluminum articles (e.g., from 50% to 100%, from 55% to 100%, from 60% to 100%, from 70% to 100%, from 75% to 100%, from 80% to 100%, or from 90% to 100%), based on the total weight of the recycled scrap. In some embodiments, the recycled scrap from EOL aluminum articles is derived from AIVs.

In some embodiments, the recycled scrap may include mixed automotive scrap. The mixed automotive scrap can include the same materials as the mixed alloy scrap (e.g., containing one or more of 5xxx, 6xxx, and/or 7xxx series aluminum alloys). In some embodiments, the recycled scrap may include mixed automotive scrap in amounts from 25% to 100% (e.g., from 30% to 95%, from 35% to 90%, from 40% to 85%, from 45% to 80%, from 50% to 75% or from 55% to 80%), based on the total weight of the recycled scrap. For example, the recycled scrap can include greater than 25% of mixed automotive scrap (e.g., greater than 30% greater than 35%, greater than 40%, greater than 45%, greater than 55%, or greater than 60%) based on the total weight of the recycled scrap. All are expressed in wt. %.

In some embodiments, mixed automotive scrap can be used in combination with one or more of EOL aluminum articles, twitch, braze alloy scrap (e.g., derived from heat exchangers), and UBC. In some embodiments, the recycled scrap may include twitch (in combination with mixed automotive scrap) in amounts from 0% to 60% (e.g., from 1% to 55%, from 5% to 50%, from 10% to 45%, from 15% to 40%, from 20% to 40%, or from 25% to 35%), based on the total weight of the recycled scrap. For example, the recycled scrap can include greater than 0% of twitch (e.g., greater than 1%, greater than 5%, greater than 10%, greater than 15%, greater than 20%, or greater than 25%), based on the total weight of the recycled scrap. All are expressed in wt. %.

In some embodiments, the recycled scrap may include UBC scrap (in combination with mixed automotive scrap, twitch, and/or braze alloy scrap) in amounts from 0% to 50% (e.g., from 1% to 45%, from 5% to 40%, from 10% to 35%, from 15% to 40%, from 20% to 40%, or from 25% to 35%), based on the total weight of the recycled scrap. For example, the recycled scrap can include greater than 0% of UBC scrap (e.g., greater than 1%, greater than 5%, greater than 10%, greater than 15%, greater than 20%, or greater than 25%), based on the total weight of the recycled scrap. All are expressed in wt. %.

In some embodiments, the recycled scrap may include braze alloy scrap (in combination with mixed automotive scrap, twitch, and/or UBC scrap) in amounts from 0% to 40% (e.g., from 1% to 35%, from 5% to 30%, from 10% to 40%, from 10% to 30%, from 15% to 40%, or from 20% to 35%), based on the total weight of the recycled scrap. For example, the recycled scrap can include greater than 0% of braze alloy scrap (e.g., greater than 1%, greater than 2%, greater than 5%, greater than 10%, greater than 15%, or greater than 20%), based on the total weight of the recycled scrap. All are expressed in wt. %.

In some embodiments, primary aluminum alloy can be used in combination with the recycled scrap to produce the aluminum alloys described herein. For example, up to 25% (e.g., up to 20%, up to 15%, up to 12%, up to 10%, up to 8%, up to 6%, up to 4%, up to 2%, or up to 1%) of primary aluminum alloy can be used to produce the aluminum alloys described herein. In some embodiments, no primary aluminum alloy is used with the recycled scrap.

### Aluminum Alloy Compositions

Suitable aluminum alloys described herein can have the following elemental composition as provided in Table 1.

TABLE 1

| Element | Weight Percentage (wt. %) |
|---|---|
| Cu | 0-1.20 |
| Fe | 0.01-0.60 |
| Mg | 0.50-3.00 |
| Mn | 0.10-0.90 |
| Si | 0.10-3.50 |
| Ti | 0-0.20 |
| Cr | 0-0.20 |
| V | 0-0.10 |
| Zn | 0-1.00 |
| Others | 0-0.15 |
| | (each) |
| | 0-0.30 |
| | (total) |

Al

In some examples, the alloys can have the following elemental composition as provided in Table 2.

TABLE 2

| Element | Weight Percentage (wt. %) |
|---|---|
| Cu | 0.001-0.90 |
| Fe | 0.15-0.50 |
| Mg | 1.00-2.50 |
| Mn | 0.20-0.80 |
| Si | 0.20-3.00 |
| Ti | 0-0.10 |
| Cr | 0-0.15 |
| V | 0-0.08 |
| Zn | 0.001-0.50 |
| Others | 0-0.15 |
| | (each) |
| | 0-0.20 |
| | (total) |

Al

In some examples, the alloys can have the following elemental composition as provided in Table 3.

TABLE 3

| Element | Weight Percentage (wt. %) |
|---|---|
| Cu | 0.05-0.75 |
| Fe | 0.20-0.40 |
| Mg | 1.40-2.40 |
| Mn | 0.40-0.70 |
| Si | 0.30-2.50 |
| Ti | 0-0.05 |
| Cr | 0-0.10 |
| V | 0-0.05 |
| Zn | 0.005-0.40 |
| Others | 0-0.05 |
| | (each) |
| | 0-0.15 |
| | (total) |

Suitable aluminum alloys described herein can have the following elemental composition as provided in Table 4.

TABLE 4

| Element | Weight Percentage (wt. %) |
|---|---|
| Cu | 0-0.50 |
| Fe | 0.01-0.60 |
| Mg | 1.00-3.00 |
| Mn | 0.10-0.90 |
| Si | 0.10-0.90 |
| Ti | 0-0.20 |
| Cr | 0-0.20 |
| V | 0-0.10 |
| Zn | 0-1.00 |
| Others | 0-0.05 |
| | (each) |
| | 0-0.15 |
| | (total) |

Al

In some examples, the alloys can have the following elemental composition as provided in Table 5.

TABLE 5

| Element | Weight Percentage (wt. %) |
|---|---|
| Cu | 0.01-0.30 |
| Fe | 0.15-0.50 |
| Mg | 1.25-2.50 |
| Mn | 0.20-0.80 |
| Si | 0.20-0.80 |
| Ti | 0-0.10 |
| Cr | 0-0.15 |
| V | 0-0.05 |
| Zn | 0-0.50 |
| Others | 0-0.05 |
| | (each) |
| | 0-0.15 |
| | (total) |

Al

In some examples, the alloys can have the following elemental composition as provided in Table 6.

TABLE 6

| Element | Weight Percentage (wt. %) |
|---|---|
| Cu | 0.05-0.20 |
| Fe | 0.20-0.40 |
| Mg | 1.60-2.40 |
| Mn | 0.40-0.70 |
| Si | 0.30-0.60 |
| Ti | 0-0.05 |
| Cr | 0-0.10 |
| V | 0-0.03 |
| Zn | 0-0.20 |
| Others | 0-0.05 |
| | (each) |
| | 0-0.15 |
| | (total) |

Al

In some examples, the alloys can have the following elemental composition as provided in Table 7.

TABLE 7

| Element | Weight Percentage (wt. %) |
|---|---|
| Cu | 0.01-0.40 |
| Fe | 0.15-0.60 |
| Mg | 1.00-2.00 |
| Mn | 0.40-0.90 |
| Si | 0.10-0.50 |
| Ti | 0-0.05 |
| Cr | 0-0.10 |
| V | 0-0.05 |
| Zn | 0-0.30 |
| Others | 0-0.05 |
| | (each) |
| | 0-0.15 |
| | (total) |

Al

In some examples, the alloys can have the following elemental composition as provided in Table 8.

TABLE 8

| Element | Weight Percentage (wt. %) |
|---|---|
| Cu | 0.15-0.40 |
| Fe | 0.25-0.55 |
| Mg | 1.50-1.90 |
| Mn | 0.40-0.80 |
| Si | 0.20-0.50 |
| Ti | 0-0.05 |
| Cr | 0-0.01 |
| V | 0-0.02 |
| Zn | 0.01-0.25 |
| Others | 0-0.05 |
| | (each) |
| | 0-0.15 |
| | (total) |

Al

In some aspects, the aluminum alloy can include copper (Cu) in an amount from 0% to about 1.20% (e.g., from about 0.001% to about 0.90%, from about 0.05% to about 1.00%, from about 0.05% to about 0.75%, from about 0.10% to about 0.90%, from about 0.20% to about 0.75%, from about 0.01% to about 0.50%, from about 0.01% to about 0.40%, from about 0.05% to about 0.30%, or from about 0.05% to about 0.20%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, 0.89%, 0.90%, 0.91%, 0.92%, 0.93%, 0.94%, 0.95%, 0.96%, 0.97%, 0.98%, 0.99%, 1.00%, 1.01%, 1.02%, 1.03%, 1.04%, 1.05%, 1.06%, 1.07%, 1.08%, 1.09%, 1.10%, 1.11%, 1.12%, 1.13%, 1.14%, 1.15%, 1.16%, 1.17%, 1.18%, 1.19%, or 1.20% Cu. All are expressed in wt. %.

In some aspects, the aluminum alloy can include iron (Fe) in an amount of from about 0.01% to about 0.60% (e.g., from about 0.05% to about 0.55%, from about 0.10% to about 0.50%, from about 0.15% to about 0.45%, from about 0.20% to about 0.40%, from about 0.25% to about 0.40%, or from about 0.30% to about 0.40%) based on the total weight of the alloy. For example, the alloy can include 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, or 0.60% Fe. All are expressed in wt. %.

In some examples, the alloys described herein include magnesium (Mg) in an amount of from about 0.50% to about 3.00% (e.g., from about 0.75% to about 2.75%, from about 1.00% to about 2.50%, from about 1.40% to about 2.40%, from about 1.20% to about 2.75%, from about 1.25% to about 2.50%, from about 1.50% to about 2.40%, or from about 1.60% to about 2.30%) based on the total weight of the alloy. For example, the alloy can include 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, 0.89%, 0.90%, 0.91%, 0.92%, 0.93%, 0.94%, 0.95%, 0.96%, 0.97%, 0.98%, 0.99%, 1.00%, 1.01%, 1.02%, 1.03%, 1.04%, 1.05%, 1.06%, 1.07%, 1.08%, 1.09%, 1.10%, 1.11%, 1.12%, 1.13%, 1.14%, 1.15%, 1.16%, 1.17%, 1.18%, 1.19%, 1.20%, 1.21%, 1.22%, 1.23%, 1.24%, 1.25%, 1.26%, 1.27%, 1.28%, 1.29%, 1.30%, 1.31%, 1.32%, 1.33%, 1.34%, 1.35%, 1.36%, 1.37%, 1.38%, 1.39%, 1.40%, 1.41%, 1.42%, 1.43%, 1.44%, 1.45%, 1.46%, 1.47%, 1.48%, 1.49%, 1.50%, 1.51%, 1.52%, 1.53%, 1.54%, 1.55%, 1.56%, 1.57%, 1.58%, 1.59%, 1.60%, 1.61%, 1.62%, 1.63%, 1.64%, 1.65%, 1.66%, 1.67%, 1.68%, 1.69%, 1.70%, 1.71%, 1.72%, 1.73%, 1.74%, 1.75%, 1.76%, 1.77%, 1.78%, 1.79%, 1.80%, 1.81%, 1.82%, 1.83%, 1.84%, 1.85%, 1.86%, 1.87%, 1.88%, 1.89%, 1.90%, 1.91%, 1.92%, 1.93%, 1.94%, 1.95%, 1.96%, 1.97%, 1.98%, 1.99%, 2.00%, 2.01%, 2.02%, 2.03%, 2.04%, 2.05%, 2.06%, 2.07%, 2.08%, 2.09%, 2.10%, 2.11%, 2.120% 2.13%, 2.14%, 2.15%, 2.16%, 2.17%, 2.18%, 2.19%, 2.20%, 2.21%, 2.22%, 2.23%, 2.24%, 2.25%, 2.26%, 2.27%, 2.28%, 2.29%, 2.30%, 2.31%, 2.32%, 2.33%, 2.34%, 2.35%, 2.36%, 2.37%, 2.38%, 2.39%, 2.40%, 2.41%, 2.42%, 2.43%, 2.44%, 2.45%, 2.46%, 2.47%, 2.48%, 2.49%, 2.50%, 2.51%, 2.52%, 2.53%, 2.54%, 2.55%, 2.56%, 2.57%, 2.58%, 2.59%, 2.60%, 2.61%, 2.62%, 2.63%, 2.64%, 2.65%, 2.66%, 2.67%, 2.68%, 2.69%, 2.70%, 2.71%, 2.72%, 2.73%, 2.74%, 2.75%, 2.76%, 2.77%, 2.78%, 2.79%, 2.80%, 2.81%, 2.82%, 2.83%, 2.84%, 2.85%, 2.86%, 2.87%, 2.88%, 2.89%, 2.90%, 2.91%, 2.92%, 2.93%, 2.94%, 2.95%, 2.96%, 2.97%, 2.98%, 2.99%, or 3.00% Mg. All are expressed in wt. %.

In some aspects, the aluminum alloy can include manganese (Mn) in an amount from about 0.10% to about 0.90% (e.g., from about 0.20% to about 0.80%, from about 0.25% to about 0.75%, from about 0.30% to about 0.70%, from about 0.40% to about 0.70%, or from about 0.50% to about 0.70%) based on the total weight of the alloy. For example, the alloy can include 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, 0.89%, or 0.90% Mn. All are expressed in wt. %.

In some aspects, the aluminum alloy can include silicon (Si) in an amount from about 0.10% to about 3.50% (e.g., from about 0.15% to about 3.25%, from about 0.20% to about 3.00%, from about 0.30% to about 2.5%, from about 0.20% to about 0.80%, from about 0.25% to about 0.75%, from about 0.30% to about 0.70%, from about 0.30% to about 0.60%, from about 0.40% to about 0.60%, or from about 0.45% to about 0.55%) based on the total weight of the alloy. For example, the alloy can include 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, 0.89%, 0.90%, 0.91%, 0.92%, 0.93%, 0.94%, 0.95%, 0.96%, 0.97%, 0.98%, 0.99%, 1.00%, 1.01%, 1.02%, 1.03%, 1.04%, 1.05%, 1.06%, 1.07%, 1.08%, 1.09%, 1.10%, 1.11%, 1.12%, 1.13%, 1.14%, 1.15%, 1.16%, 1.17%, 1.18%, 1.19%, 1.20%, 1.21%, 1.22%, 1.23%, 1.24%, 1.25%, 1.26%, 1.27%, 1.28%, 1.29%, 1.30%, 1.31%, 1.32%, 1.33%, 1.34%, 1.35%, 1.36%, 1.37%, 1.38%, 1.39%, 1.40%, 1.41%, 1.42%, 1.43%, 1.44%, 1.45%, 1.46%, 1.47%, 1.48%, 1.49%, 1.50%, 1.51%, 1.52%, 1.53%, 1.54%, 1.55%, 1.56%, 1.57%, 1.58%, 1.59%, 1.60%, 1.61%, 1.62%, 1.63%, 1.64%, 1.65%, 1.66%, 1.67%, 1.68%, 1.69%, 1.70%, 1.71%, 1.72%, 1.73%, 1.74%, 1.75%, 1.76%, 1.77%, 1.78%, 1.79%, 1.80%, 1.81%, 1.82%, 1.83%, 1.84%, 1.85%, 1.86%, 1.87%, 1.88%, 1.89%, 1.90%, 1.91%, 1.92%, 1.93%, 1.94%, 1.95%, 1.96%, 1.97%, 1.98%, 1.99%, 2.00%, 2.01%, 2.02%, 2.03%, 2.04%, 2.05%, 2.06%, 2.07%, 2.08%, 2.09%, 2.10%, 2.11%, 2.12%, 2.13%, 2.14%, 2.15%, 2.16%, 2.17%, 2.18%, 2.19%, 2.20%, 2.21%, 2.22%, 2.23%, 2.24%, 2.25%, 2.26%, 2.27%, 2.28%, 2.29%, 2.30%, 2.31%, 2.32%, 2.33%, 2.34%, 2.35%, 2.36%, 2.37%, 2.38%, 2.39%, 2.40%, 2.41%, 2.42%, 2.43%, 2.44%, 2.45%, 2.46%, 2.47%, 2.48%, 2.49%, 2.50%, 2.51%, 2.52%, 2.53%, 2.54%, 2.55%, 2.56%, 2.57%, 2.58%, 2.59%, 2.60%, 2.61%, 2.62%, 2.63%, 2.64%, 2.65%, 2.66%, 2.67%, 2.68%, 2.69%, 2.70%, 2.71%, 2.72%, 2.73%, 2.74%, 2.75%, 2.76%, 2.77%, 2.78%, 2.79%, 2.80%, 2.81%, 2.82%, 2.83%, 2.84%, 2.85%, 2.86%, 2.87%, 2.88%, 2.89%, 2.90%, 2.91%, 2.92%, 2.93%, 2.94%, 2.95%, 2.96%, 2.97%, 2.98%, 2.99%, 3.00%, 3.01%, 3.02%, 3.03%, 3.04%, 3.05%, 3.06%, 3.07%, 3.08%, 3.09%, 3.10%, 3.11%, 3.12%, 3.13%, 3.14%, 3.15%, 3.16%, 3.17%, 3.18%, 3.19%, 3.20%, 3.21%, 3.22%, 3.23%, 3.24%, 3.25%, 3.26%, 3.27%, 3.28%, 3.29%, 3.30%, 3.31%, 3.32%, 3.33%, 3.34%, 3.35%, 3.36%, 3.37%, 3.38%, 3.39%, 3.40%, 3.41%, 3.42%, 3.43%, 3.44%, 3.45%, 3.46%, 3.47%, 3.48%, 3.49%, or 3.50% Si. All are expressed in wt. %.

In some aspects, the aluminum alloy can include zinc (Zn) in an amount from 0% to about 1.00% (e.g., from about 0.001% to about 1.00%, from about 0.001% to about 0.50%, from about 0.005% to about 0.40%, from about 0.01% to about 0.50%, from about 0.05% to about 0.40%, or from about 0.10% to about 0.35%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, 0.89%, 0.90%, 0.91%, 0.92%, 0.93%, 0.94%, 0.95%, 0.96%, 0.97%, 0.98%, 0.99%, or 1.00% Zn. In some cases, Zn is not present in the alloy (i.e., 0%). All are expressed in wt. %.

In some examples, the alloys described herein include titanium (Ti) in an amount of from 0% to about 0.20% (e.g., from about 0.001% to about 0.15%, from about 0.005% to about 0.10%, from about 0.008% to about 0.08%, or from about 0.01% to about 0.05%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, or 0.20% Ti. In some cases, Ti is not present in the alloy (i.e., 0%). All are expressed in wt. %.

In some examples, the alloys described herein include chromium (Cr) in an amount of from 0% to about 0.20% (e.g., from 0% to about 0.10%, from about 0.001% to about 0.10%, from about 0.05% to about 0.08%, or from about 0.01% to about 0.05%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, or 0.20% Cr. In some cases, Cr is not present in the alloy (i.e., 0%). All are expressed in wt. %.

In some examples, the alloys described herein include vanadium (V) in an amount of from 0% to about 0.10% (e.g., from 0% to about 0.08%, from 0% to about 0.05%, from about 0.001% to about 0.06%, from about 0.005% to about 0.05%, or from about 0.008% to about 0.02%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, or 0.10% V. In some cases, V is not present in the alloy (i.e., 0%). All are expressed in wt. %.

In some examples, the alloys described herein include zirconium (Zr) in an amount of from 0% to about 0.05% (e.g., from 0.0001% to about 0.02%, from about 0.002% to about 0.015%, from about 0.0003% to about 0.01%, or from about 0.0004% to about 0.001%) based on the total weight of the alloy. For example, the alloy can include 0.0001%, 0.0002%, 0.0003%, 0.0004%, 0.0005%, 0.0006%, 0.0007%, 0.0008%, 0.0009%, 0.001%, 0.002%, 0.003%, 0.004%, 0.005%, 0.006%, 0.007%, 0.008%, 0.009%, 0.01%, 0.02%, 0.03%, 0.04%, or 0.05% Zr. In some cases, Zr is not present in the alloy (i.e., 0%). All are expressed in wt. %.

Optionally, the aluminum alloy described herein can further include other minor elements, sometimes referred to as impurities, in amounts of about 0.05 wt. % or below, about 0.04 wt. % or below, about 0.03 wt. % or below, about 0.02 wt. % or below, or about 0.01 wt. % or below. These impurities may include, but are not limited to, Ni, Sc, Hf, Sn, Ga, Bi, Na, Pb, or combinations thereof. Accordingly, Ni, Sc, Hf, Sn, Ga, Bi, Na, or Pb, may each be present in the alloys in amounts of about 0.05 wt. % or below, about 0.04 wt. % or below, about 0.03 wt. % or below, about 0.02 wt. % or below, or about 0.01 wt. % or below, for example. The sum of all impurities does not exceed about 0.50 wt. % (e.g., does not exceed about 0.40 wt. %, about 0.30 wt. %, about 0.25 wt. %, about 0.20 wt. % about 0.15 wt. %, or about 0.10 wt. %). All expressed in wt. %. In some aspects, the remaining percentage of the alloy is aluminum.

Thus, in some aspects, the aluminum alloy can include from about 0.10 wt. % to 0.90 wt. % Si and from 1 wt. % to 3 wt. % Mg. In some aspects, the ratio of Si wt. % to wt. % Mg in the aluminum alloy (e.g., Si:Mg) can be from 0.05:1 to 0.60:1 (e.g., from 0.10:1 to 0.55:1, from 0.15:1 to 0.50:1, from 0.20:1 to 0.45:1, from 0.20:1 to 0.40:1, from 0.24:1 to 0.35:1, or from 0.30:1 to 0.45:1).

In some aspects, the aluminum alloy includes a combined concentration of Si, Mn, and Fe in specific quantities that satisfies the following equation:

Si+Mn−(Fe/2)≥0.6 (Eq. 1)

In some aspects, the aluminum alloy has a value from 0.60 to 1.20 according to Equation 1 (e.g., from 0.65 to 1.15, from 0.70 to 1.10, from 0.70 to 1.05, from 0.75 to 1.00, from 0.80 to 1.00, from 0.85 to 1.00, or from 0.90 to 1.00). For example, the value for the aluminum alloy according to Equation 1 can be 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, or 1.20.

In some aspects, the aluminum alloy may employ a substantially balanced Si (e.g., at or near 0 excess Si) to slightly under-balanced Si approach in alloy design instead of a high excess Si approach. In certain aspects, the excess Si content can be about −1.70 to 0.1. Excess Si as used herein is defined by the equation:

Excess Si=(Si)−[(Mg)−0.167(Fe+Mn+Cr)]*

*All alloying elements represent the wt. % of the alloying element in the aluminum alloy composition.

For example, excess Si can be about −1.70, −1.69, −1.68, −1.67, −1.66, −1.65, −1.64, −1.63, −1.62, −1.61, −1.60, −1.59, −1.58, −1.57, −1.56, −1.55, −1.54, −1.53, −1.52, −1.51, −1.50, −1.49, −1.48, −1.47, −1.46, −1.45, −1.44, −1.43, −1.42, −1.41, −1.40, −1.39, −1.38, −1.37, −1.36, −1.35, −1.34, −1.33, −1.32, −1.31, −1.30, −1.29, −1.28, −1.27, −1.26, −1.25, −1.24, −1.23, −1.22, −1.21, −1.20, −1.19, −1.18, −1.17, −1.16, −1.15, −1.14, −1.13, −1.12, −1.11, −1.10, −1.09, −1.08, −1.07, −1.06, −1.05, −1.04, −1.03, −1.02, −1.01, −1.00, −0.99, −0.98, −0.97, −0.96, −0.95, −0.94, −0.93, −0.92, −0.91, −0.90, −0.89, −0.88, −0.87, −0.86, −0.85, −0.84, −0.83, −0.82, −0.81, −0.80, −0.79, −0.78, −0.77, −0.76, −0.75, −0.74, −0.73, −0.72, −0.71, −0.70, −0.69, −0.68, −0.67, −0.66, −0.65, −0.64, −0.63, −0.62, −0.61, −0.60, −0.59, −0.58, −0.57, −0.56, −0.55, −0.54, −0.53, −0.52, −0.51, −0.50, −0.49, −0.48, −0.47, −0.46, −0.45, −0.44, −0.43, −0.42, −0.41, −0.40, −0.39, −0.38, −0.37, −0.36, −0.35, −0.34, −0.33, −0.32, −0.31, −0.30, −0.29, −0.28, −0.27, −0.26, −0.25, −0.24, −0.23, −0.22, −0.21, −0.20, −0.19, −0.18, −0.17, −0.16, −0.15, −0.14, −0.13, −0.12, −0.11, −0.10, −0.09, −0.08, −0.07, −0.06, −0.05, −0.04, −0.03, −0.02, −0.01, 0, 0.01, 0.02, 0.03, 0.04, 0.05, 0.06, 0.07, 0.08, 0.09, or 0.10. In some aspects, the aluminum alloy has a Cu content of less than about 0.20 wt. %, a Si:Mg ratio from about 0.20:1 to about 0.45:1, and an excess Si content from about −1.30 to 0.

### Properties of New Aluminum Alloys

The aluminum alloys described herein surprisingly exhibit both high strength (e.g., after paint bake) and formability. The aluminum alloys described herein also demonstrate good tensile properties, bendability, and deep-drawability.

In some aspects, the aluminum alloys described herein can have an ultimate tensile strength (Rm) after batch annealing (e.g., after batch annealing for 2 hours at 330° C.) of from 120 MPa to about 250 MPa (e.g., from about 125 MPa to about 240 MPa, from about 130 MPa to about 230 MPa, from about 140 MPa to about 220 MPa, or from about 150 MPa to about 200 MPa). Further, the aluminum alloys as described herein can have an Rm after continuous annealing and solution heat treatment (e.g., CASH at 550° C. for 0 seconds) of from 160 MPa to 240 MPa (e.g., from 170 MPa to 230 MPa, from 175 MPa to 225 MPa, from 180 MPa to 225 MPa, or from 190 MPa to 210 MPa). Further, the aluminum alloys as described herein can have an Rm after continuous annealing and solution heat treatment (e.g., CASH at 550° C. for 60 seconds) of from 180 MPa to 250 MPa (e.g., from 185 MPa to 240 MPa, from 190 MPa to 235 MPa, from 200 MPa to 230 MPa, or from 205 MPa to 225 MPa).

In some aspects, the aluminum alloys described herein can have can have a yield strength (Rp0.2) after batch annealing (e.g., after batch annealing for 2 hours at 330° C.) of from about 40 MPa to 140 MPa (e.g., from about 50 MPa to about 130 MPa, from about 60 MPa to about 125 MPa, or from about 80 MPa to about 110 MPa). Rp0.2 refers to the amount of stress that will result in a plastic strain of 0.2%. Further, the aluminum alloys as described herein can have an Rp0.2 after continuous annealing and solution heat treatment (e.g., CASH at 550° C. for 0 seconds) of from about 80 MPa to about 120 MPa (e.g., from about 85 MPa to about 115 MPa, from about 90 MPa to about 110 MPa, from about 95 MPa to about 110 MPa, or from about 95 MPa to about 105 MPa). Further, the aluminum alloys as described herein can have an Rp0.2 after continuous annealing and solution heat treatment (e.g., CASH at 550° C. for 60 seconds) of from about 85 MPa to about 125 MPa (e.g., from about 90 MPa to about 120 MPa, from about 90 MPa to about 115 MPa, from about 95 MPa to about 115 MPa, or from about 100 MPa to about 115 MPa).

In some aspects, the aluminum alloys described herein can have an Rm after batch annealing (e.g., after batch annealing for 2 hours at 330° C. to a T8x temper) of from about 120 MPa to about 250 MPa (e.g., from about 125 MPa to about 240 MPa, from about 130 MPa to about 230 MPa, from about 140 MPa to about 220 MPa, or from about 150 MPa to about 200 MPa). Further, the aluminum alloys as described herein can have an Rm after continuous annealing and solution heat treatment (e.g., CASH at 550° C. for 0 seconds to a T8x temper) of from about 160 MPa to about 240 MPa (e.g., from about 170 MPa to about 230 MPa, from about 175 MPa to about 225 MPa, from about 180 MPa to about 225 MPa, or from about 190 MPa to about 210 MPa). Further, the aluminum alloys as described herein can have an Rm after continuous annealing and solution heat treatment (e.g., CASH at 550° C. for 60 seconds to a T8x temper) of from about 180 MPa to about 250 MPa (e.g., from about 185 MPa to about 240 MPa, from about 190 MPa to about 235 MPa, from about 200 MPa to about 230 MPa, or from about 205 MPa to about 225 MPa).

In some aspects, the aluminum alloys described herein can have a Rp0.2 after batch annealing (e.g., after batch annealing to a T8x temper) of from about 50 MPa to about 140 MPa (e.g., from about 60 MPa to about 130 MPa, from about 70 MPa to about 125 MPa, or from about 80 MPa to about 115 MPa). Further, the aluminum alloys as described herein can have an Rp0.2 after continuous annealing and solution heat treatment (e.g., CASH at 330° C. for 0 seconds to a T8x temper) of from about 80 MPa to about 120 MPa (e.g., from about 85 MPa to about 115 MPa, from about 90 MPa to about 115 MPa, from about 95 MPa to about 110 MPa, or from about 95 MPa to about 105 MPa). Further, the aluminum alloys as described herein can have an Rp0.2 after continuous annealing and solution heat treatment (e.g., CASH at 550° C. for 60 seconds to a T8x temper) of from about 90 MPa to 1 about 30 MPa (e.g., from about 85 MPa to about 125 MPa, from about 90 MPa to about 120 MPa, from about 95 MPa to about 115 MPa, or from about 100 MPa to about 115 MPa).

In some aspects, the aluminum alloys described herein can have a yield strength (Rp0.2) of from 160 MPa to 250 MPa when tested according to ISO 6892-1 (2016) after a paint-bake cycle. For example, the paint cycle may comprise 2% pre-strain followed by thermal treatment at a temperature of about 185° C. for about 20 minutes. In some embodiments, the aluminum alloys as described herein can have an Rp0.2 after a paint bake cycle of from about 160 MPa to about 250 MPa (e.g., from about 180 MPa to about 240 MPa, from about 190 MPa to about 235 MPa, from about 200 MPa to about 230 MPa, or from about 205 MPa to about 225 MPa).

In some aspects, the aluminum alloys as described herein can have a total elongation (as measured by ISO/EN A80) of at least 15% (e.g., at least 16%, at least 17%, at least 18%, at least 19%, at least 20%, at least 16%, at least 21%, at least 22%, at least 23%, at least 24%, or at least 25%). In terms of ranges, the aluminum alloys can have an elongation of from 15% to 30% (e.g., from 16% to 28%, from 17% to 26%, from 18% to 25%, from 19% to 24% from 20% to 23%, or from 21% to 22.5%).

In some aspects, the aluminum alloys as described herein can have a uniform elongation (Ag) (as measured by ISO/EN Ag) of at least about 15% (e.g., at least about 160%, at least about 17%, at least about 18%, at least about 19%, at least about 20%, at least about 21%, at least about 22%, at least about 23%, at least about 24%, or at least about 25%). In terms of ranges, the aluminum alloys can have an elongation of from about 15% to about 25% (e.g., from about 16% to about 24%, from about 16.5% to about 23%, from about 17% to about 22%, from about 17% to about 21.5%, from about 17.5% to about 21%, from about 17.5% to about 20.5%, or from about 18% to about 20%).

In some aspects, the aluminum alloys as described can have an r(8-12) value in any individual direction or in all directions (longitudinal (L), diagonal (D), and/or transverse (T) to the rolling direction) of at least about 0.40 (e.g., at least about 0.41, at least about 0.42, at least about 0.43, at least about 0.44, at least about 0.45, at least about 0.46, at least about 0.47, at least about 0.48, at least about 0.49, at least about 0.50, at least about 0.51, at least about 0.52, at least about 0.53, at least about 0.54, at least about 0.55, at least about 0.56, at least about 0.57, at least about 0.58, at least about 0.59, at least about 0.60, at least about 0.61, at least about 0.62, at least about 0.63, at least about 0.64, at least about 0.65, at least about 0.66, at least about 0.67, at least about 0.68, at least about 0.69, at least about 0.70, at least about 0.71, at least about 0.72, at least about 0.73, at least about 0.74, at least about 0.75, at least about 0.76, at least about 0.77, at least about 0.78, at least about 0.79, or at least about 0.80). In terms of ranges, the aluminum alloy can have an r(8-12) value in any direction or all directions (longitudinal (L), diagonal (D), and/or transverse (T) to the rolling direction) of from 0.40 to 0.80 (e.g., from 0.42 to 0.78, from 0.45 to 0.75, from 0.46 to 0.70, from 0.50 to 0.80, from 0.52 to 0.78, from 0.55 to 0.78, from 0.56 to 0.76, from 0.60 to 0.80, from 0.62 to 0.78, from 0.64 to 0.77, from 0.66 to 0.76, or from 0.68 to 0.74).

In some aspects, the aluminum alloys as described can have an r(10) value in any individual direction or in all directions (longitudinal (L), diagonal (D), and/or transverse (T) to the rolling direction) of at least about 0.40 (e.g., at least about 0.41, at least about 0.42, at least about 0.43, at least about 0.44, at least about 0.45, at least about 0.46, at least about 0.47, at least about 0.48, at least about 0.49, at least about 0.50, at least about 0.51, at least about 0.52, at least about 0.53, at least about 0.54, at least about 0.55, at least about 0.56, at least about 0.57, at least about 0.58, at least about 0.59, at least about 0.60, at least about 0.61, at least about 0.62, at least about 0.63, at least about 0.64, at least about 0.65, at least about 0.66, at least about 0.67, at least about 0.68, at least about 0.69, at least about 0.70, at least about 0.71, at least about 0.72, at least about 0.73, at least about 0.74, at least about 0.75, at least about 0.76, at least about 0.77, at least about 0.78, at least about 0.79, or at least about 0.80). The r-value measured at a strain rate of 10% is indicated as r(10). In terms of ranges, the aluminum alloy can have an r(10) value in any direction or all directions (longitudinal (L), diagonal (D), and/or transverse (T) to the rolling direction) of from about 0.40 to about 0.80 (e.g., from 0.42 to 0.78, from 0.45 to 0.75, from 0.46 to 0.70, from 0.50 to 0.80, from 0.52 to 0.78, from 0.55 to 0.78, from 0.56 to 0.76, from 0.60 to 0.80, from about 0.62 to about 0.78, from about 0.64 to about 0.77, from about 0.66 to about 0.76, or from about 0.68 to about 0.74).

In some aspects, the aluminum alloys as described can have an n(10-20) value in any direction or all directions (longitudinal (L), diagonal (D), and/or transverse (T) to the rolling direction) of at least about 0.16 (e.g., at least about 0.17, at least about 0.18, at least about 0.19, at least about 0.20, at least about 0.21, at least about 0.22, at least about 0.23, at least about 0.24, at least about 0.25, at least about 0.26, at least about 0.27, at least about 0.28, at least about 0.29, or at least about 0.30). In terms of ranges, the aluminum alloy can have an n (10-20) value in any individual direction or in all directions (longitudinal (L), diagonal (D), and/or transverse (T) to the rolling direction) of from about 0.16 to about 0.30 (e.g., of from about 0.17 to about 0.28, from about 0.18 to about 0.26, from about 0.20 to about 0.26, or of from about 0.20 to about 0.25).

In some aspects, the aluminum alloys as described can have an n(10-15) value in any direction or all directions (longitudinal (L), diagonal (D), and/or transverse (T) to the rolling direction) of at least about 0.16 (e.g., at least about 0.17, at least about 0.18, at least about 0.19, at least about 0.20, at least about 0.21, at least about 0.22, at least about 0.23, at least about 0.24, at least about 0.25, at least about 0.26, at least about 0.27, at least about 0.28, at least about 0.29, or at least about 0.30). In terms of ranges, the aluminum alloy can have an n (10-20) value in any individual direction or in all directions (longitudinal (L), diagonal (D), and/or transverse (T) to the rolling direction) of from about 0.16 to about 0.30 (e.g., of from about 0.17 to about 0.28, from about 0.18 to about 0.26, from about 0.20 to about 0.26, or of from about 0.20 to about 0.25).

### Methods of Producing the Aluminum Alloys and Aluminum Alloy Products

The aluminum alloys produced from the recycled content alloys can be used to cast various metallic cast products, such as billets, ingots, or strips. Methods of producing an aluminum sheet are also described herein. The aluminum alloy can be cast and then further processing steps may be performed. In some examples, the processing steps include a casting step, a pre-heating and/or a homogenizing step, one or more hot rolling steps, one or more cold rolling steps, a solution-heat treatment step, a pre-aging step, and an artificial aging step.

The aluminum alloys described herein can be cast into ingots using a direct chill (DC) process or a continuous casting (CC) process. The DC casting process is performed according to standards commonly used in the aluminum industry as known to one of skill in the art. The CC casting process can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

The cast aluminum alloy product can be processed by any means known to those of ordinary skill in the art. Optionally, the cast aluminum alloy product can be processed, using processing steps as described herein, to prepare sheets, plates, or shates. Example processing steps include, but are not limited to, homogenization, hot rolling, cold rolling, annealing, solution heat treatment, pre-aging, and/or artificial aging.

In a homogenization step, a cast product may be heated to a homogenization temperature, such as a temperature ranging from about 400° C. to about 600° C. For example, the cast product can be heated to a temperature of 400° C., 410° C., 420° C., 430° C., 440° C., 450° C., 460° C., 470° C., 480° C., 490° C., 500° C., 510° C., 520° C., 530° C., 540° C., 550° C., 560° C., 570° C., 580° C., 590° C., or 600° C. In some embodiments, the heating rate to the peak metal temperature can be about 70° C./hour or less, about 60° C./hour or less, or about 50° C./hour or less.

The product may then be allowed to soak (i.e., held at the indicated temperature) for a period of time to form a homogenized product. In some examples, the total time for the homogenization step, including the heating and soaking phases, can be up to about 20 hours. For example, the homogenization step may include heating the product up to about 550° C. and soaking the product for a total time of up to about 10 hours. In some cases, the homogenization step includes multiple processes. In some non-limiting examples, the homogenization step includes heating a cast product to a first temperature and soaking the cast product for a first period of time followed by heating the cast product to a second temperature and soaking the cast product for a second period of time.

Following a homogenization step, a hot rolling step can be performed. Prior to the start of hot rolling, the homogenized product can be allowed to cool to a desired temperature, such as from about 200° C. to about 425° C. For example, the homogenized product can be allowed to cool to a temperature of from about 200° C. to about 400° C., about 250° C. to about 375° C., about 300° C. to about 425° C., or from about 350° C. to about 400° C. The homogenized product can then be hot rolled at a hot rolling temperature, for example, from about 200° C. to about 450° C., to produce a hot rolled intermediate product (e.g., a hot rolled plate, a hot rolled shate, or a hot rolled sheet) having a gauge from 3 mm to 100 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, or anywhere in between). For example, the homogenized product can be hot rolled to an intermediate gauge of 9.5 mm from an initial gauge of 65 mm.

During hot rolling, temperatures and other operating parameters can be controlled so that the temperature of the hot rolled intermediate product upon exit from the hot rolling mill is less than about 400° C. For example, the temperature of the hot rolled intermediate product upon exit from the hot rolling mill can be less than about 390° C., less than about 380° C., less than about 370° C., less than about 360° C., less than about 350° C., less than about 340° C., less than about 330° C., less than about 325° C., less than about 320° C., less than about 310° C., less than about 300° C., less than about 290° C., less than about 280° C., less than about 270° C., less than about 260° C., or less than about 250° C. The exit temperature of the hot rolled intermediate product from the hot rolling step can control the microstructure of the aluminum alloy. In particular, aluminum alloys produced from a high content of recycled scrap require critically controlled heating rates, temperatures, and other operating parameters during the hot rolling step to produce an aluminum alloy product with the mechanical properties recited herein. The hot rolled intermediate product can then be coil cooled in a furnace. In some embodiments, the hot rolled intermediate product is coil cooled to a temperature from about 10° C. to about 100° C. For example, the temperature of the hot rolled intermediate product upon exit from the hot rolling mill can be coil cooled to a temperature of about 10° C., about 20° C., about 25° C., about 30° C., about 40° C., about 50° C., about 60° C., about 70° C., about 80° C., about 90° C., or about 100° C. The total time for the coil cooling can be up to about 30 hours. In some embodiments, the hot rolled intermediate product is coil cooled to a temperature of about 24° C. for about 24 hours.

Cast, homogenized, or hot-rolled intermediate products can be cold rolled using cold rolling mills into thinner products, such as a cold rolled sheet. The cold rolled product can have a gauge between about 0.5 to about 10 mm, e.g., between about 0.7 to about 6.5 mm. Optionally, the cold rolled product can have a gauge of about 0.5 mm, about 1.0 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, or about 10.0 mm. The cold rolling can be performed to result in a final gauge thickness that represents a gauge reduction of up to about 85% (e.g., up to about 10%, up to about 20%, up to about 30%, up to about 40%, up to about 50%, up to about 60%, up to about 70%, up to about 80%, or up to about 85% reduction) as compared to a gauge prior to the start of cold rolling. In some embodiments, the cold rolling step may include one or more cold rolling steps to achieve the desired gauge thickness reduction. Optionally, the process for producing the aluminum alloy can include an interannealing step (e.g., between one or more cold rolling steps).

Subsequently, a cast, homogenized, or rolled product can optionally undergo one or more solution heat treatment steps. The cast, homogenized, or rolled product can be heated to a peak metal temperature (PMT) of up to about 600° C. (e.g., from about 400° C. to about 600° C.) and soaked for a period of time at the PMT. In some embodiments, the cast, homogenized, or rolled product is heated to a PMT from about 400° C. to about 600° C. (e.g., from about 430° C. to about 500° C., from about 440° C. to about 490° C., from about 450° C. to about 480° C., or from about 460° C. to about 475° C.). In some embodiments, the cast, homogenized, or rolled product can be soaked at the PMT (e.g., about 550° C.) for a soak time of up to about 10 minutes (e.g., 0 seconds, 60 seconds, 75 seconds, 90 seconds, 2 minutes, 3 minutes, 4 minutes, or 5 minutes). In some embodiments, the cast, homogenized, or rolled product can be heated to the peak metal temperature in about 10 seconds.

In some examples, the heating rate for the solution heat treatment step can be from about 250° C./hour to about 350° C./hour (e.g., about 250° C./hour, about 255° C./hour, about 260° C./hour, about 265° C./hour, about 270° C./hour, about 275° C./hour, about 280° C./hour, about 285° C./hour, about 290° C./hour, about 295° C./hour, about 300° C./hour, about 305° C./hour, about 310° C./hour, about 315° C./hour, about 320° C./hour, about 325° C./hour, about 330° C./hour, about 335° C./hour, about 340° C./hour, about 345° C./hour, or about 350° C./hour).

Heating rates can be significantly higher, especially for cast, homogenized, or rolled product processed through a continuous solution heat treatment line. Heating rates in continuous heat treating lines can range from about 5° C./second to about 20° C./second (e.g., 5° C./second, 6° C./second, 7° C./second, 8° C./second, 9° C./second, 10° C./second, 11° C./second, 12° C./second, 13° C./second, 14° C./second, 15° C./second, 16° C./second, 17° C./second, 18° C./second, 19° C./second, or 20° C./second).

In some embodiments, after solution heat treatment, the hot product can be rapidly cooled (e.g., water quenched). For example, the hot product can be cooled at rates greater than 50° C./second (° C./s) to a temperature from about 500° C. to about 200° C. In one example, the hot product is cooled at a quench rate of above 200° C./second from a temperature of about 450° C. to a temperature of about 200° C. Optionally, the cooling rates can be faster in other cases.

After the solution heat treatment step, the heat-treated product can optionally undergo a pre-aging treatment, such as by reheating before coiling. The pre-aging treatment can be performed at a suitable temperature, such as from about 70° C. to about 125° C., for a period of time of up to about 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the heat-treated product through a heating device, such as a device that emits radiant heat, convective heat, induction heat, infrared heat, or the like.

The mechanical properties of the final product can be controlled by various aging conditions depending on the desired use. In some cases, the aluminum alloy product described herein can be delivered to customers in a Tx temper (for example, a T1 temper, a T4 temper, a T5 temper, a T6 temper, a T7 temper, a T8x temper (e.g., a T81 temper or a T82 temper)), a W temper, an O temper, or an F temper. In some examples, an artificial aging step can be performed. The artificial aging step develops the high strength property of the alloys and optimizes other desirable properties in the alloys. The artificial aging step can be performed at a suitable temperature, such as from about 100° C. to about 250° C. (e.g., at about 180° C. or at about 225° C.). The aging step can be performed for a period of time from about 10 minutes to about 36 hours (e.g., for about 30 minutes or for about 24 hours). In some examples, the artificial aging step can be performed at 180° C. for 30 minutes to result in a T81-temper. In some examples, the artificial aging step can be performed at 185° C. for 25 minutes to result in a T81-temper. In some further examples, the artificial aging step can be performed at 225° C. for 30 minutes to result in a T82-temper. In some still further examples, the alloys are subjected to a natural aging step. The natural aging step can result in a T4-temper.

### Methods of Using Aluminum Alloys

The aluminum alloys described herein can each be used in automotive applications and other transportation applications, including aircraft and railway applications. For example, the aluminum alloys can be used to prepare automotive structural parts, such as bumpers, side beams, roof beams, cross beams, pillar reinforcements (e.g., A-pillars, B-pillars, and C-pillars), inner panels, outer panels, side panels, inner hoods, outer hoods, or trunk lid panels. The aluminum alloys and methods described herein can also be used in aircraft or railway vehicle applications, to prepare, for example, external and internal panels. In some examples, the aluminum alloys can be used in aerospace structural and non-structural parts or in marine structural or non-structural parts.

The aluminum alloys and methods described herein can also be used in electronics applications. For example, the aluminum alloys and methods described herein can be used to prepare housings for electronic devices, including mobile phones and tablet computers. In some examples, the aluminum alloys can be used to prepare housings for the outer casings of mobile phones (e.g., smart phones) and tablet bottom chassis.

The aluminum alloys described herein can be used to make aluminum alloy products in the form of plates, extrusions, castings, and forgings or other suitable products. The products can be made using techniques as known to those of ordinary skill in the art. In some examples, the aluminum alloys can be used to produce extrusions. For example, the aluminum alloys described herein can be used to produce extruded aluminum alloy products.

The aluminum alloys and methods described herein can also be used in other applications as desired. The aluminum alloys described herein can be provided as aluminum alloy sheets and/or plates suitable for further processing by an end user. For example, an aluminum alloy sheet can be further subjected to surface treatments by an end user for use as an architectural skin panel for aesthetic and structural purposes.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. During the studies described in the following examples, conventional procedures were followed, unless otherwise stated. Some of the procedures are described below for illustrative purposes.

### EXAMPLES

### Example 1

Aluminum alloys were produced by direct chill casting to prepare a 65 mm ingot. The aluminum alloy samples were homogenized by heating the ingot to 550° C. at a heating rate of 50° C./h and holding the ingot at 550° C. for 10 hours. Samples were then hot rolled from a gauge of 65 mm to a gauge of 9.5 mm at an exit temperature of 350° C. Coil cooling was simulated in a furnace shut down at 350° C. and the sample was cooled to 24° C. over a period of 24 hours. Samples were then cold rolled to a gauge of 6.5 mm. Samples were then solutionized at 550° C. for 60 seconds (with a 10 second heat-up time to the solution heat treatment temperature) and the samples were then water quenched. Samples were then pre-aged at 90° C. for 2 hours. The samples were then artificially aged to a specific temper, as described below, and were then tested for mechanical properties, as detailed below.

As shown in Table 9, Comparative Example Alloys A and B were intended to be representative of the existing art and were prepared as a comparative to Example Alloys 1-9, which are representative of the aluminum alloys as described herein. Table 9 provides the recycled scrap content and types of recycled scrap in Examples 1-9 and Comparative Example Alloys A and B. Example Alloys 1-3 included 25 wt. % UBC scrap and 75 wt. % mixed recycled alloys, Example Alloys 4-6 included 50 wt. % UBC scrap and 50 wt. % mixed recycled alloys, and Example Alloys 7-9 included 75 wt. % UBC scrap and 25 wt. % mixed recycled alloys. Comparatives A and B did not include any mixed alloys, and Comparative Example A had a maximum of 25 wt. % UBC.

TABLE 9

| | Recycled Content (wt. %) | | | |
|---|---|---|---|---|
| | | Mixed Alloy Scrap | | |
| | | Type of | 5xxx | 6xxx |
| | UBC | Mixed Alloy | Series | Series |
| Element | Scrap | Scrap | Scrap | Scrap |
| Example 1 | 25 | 5xxx in 6xxx | 18.75 | 56.25 |
| Example 2 | 25 | 5xxx/6xxx | 37.5 | 37.5 |
| Example 3 | 25 | 6xxx in 5xxx | 56.25 | 18.75 |
| Example 4 | 50 | 5xxx in 6xxx | 12.5 | 37.5 |
| Example 5 | 50 | 5xxx/6xxx | 25 | 25 |
| Example 6 | 50 | 6xxx in 5xxx | 37.5 | 12.5 |
| Example 7 | 75 | 5xxx in 6xxx | 6.25 | 18.75 |
| Example 8 | 75 | 5xxx/6xxx | 12.5 | 12.5 |
| Example 9 | 75 | 6xxx in 5xxx | 18.75 | 6.25 |
| Comp. A | 43.75 | Not Mixed | 25 | 31.25 |
| Comp. B | — | Not Mixed | 100 | — |

The aluminum alloy compositions for Examples Alloys 1-9 and Comparative Alloys A and B are shown in Table 10. In Table 10, all values are in weight percent (wt. %) of the whole. The alloys can contain up to 0.15 wt. % total impurities and the remainder is aluminum.

TABLE 10

| | Aluminum Alloy Compositions (wt. %) | | | | | | | |
|---|---|---|---|---|---|---|---|---|
| | Si | Mg | Fe | Cu | Mn | Cr | Ti | V |
| Ex. Alloy 1 | 0.68 | 1.41 | 0.27 | 0.07 | 0.39 | 0.02 | 0.02 | 0.01 |
| Ex. Alloy 2 | 0.52 | 2.18 | 0.27 | 0.06 | 0.42 | 0.03 | 0.02 | 0.01 |
| Ex. Alloy 3 | 0.35 | 2.94 | 0.28 | 0.05 | 0.44 | 0.04 | 0.02 | 0.01 |
| Ex. Alloy 4 | 0.58 | 1.39 | 0.30 | 0.10 | 0.54 | 0.03 | 0.02 | 0.01 |
| Ex. Alloy 5 | 0.47 | 1.90 | 0.31 | 0.09 | 0.56 | 0.04 | 0.02 | 0.01 |
| Ex. Alloy 6 | 0.36 | 2.41 | 0.31 | 0.09 | 0.58 | 0.04 | 0.02 | 0.01 |
| Ex. Alloy 7 | 0.47 | 1.37 | 0.34 | 0.13 | 0.69 | 0.04 | 0.02 | 0.01 |
| Ex. Alloy 8 | 0.42 | 1.63 | 0.34 | 0.13 | 0.70 | 0.04 | 0.02 | 0.01 |
| Ex. Alloy 9 | 0.36 | 1.88 | 0.35 | 0.12 | 0.71 | 0.02 | 0.02 | 0.01 |
| Comp. A | 0.40 | 1.46 | 0.30 | 0.37 | 0.43 | 0.013 | 0.0184 | 0.0059 |
| Comp. B | 0.10 | 3.17 | 0.20 | 0.01 | 0.42 | 0.0006 | 0.0202 | 0.0052 |

Table 11 provides the liquidus temperature, solidus temperature, Scheil temperature, and solvus temperature for Examples Alloys 1-9 and Comparative Alloys A and B. The liquidus temperature is the equilibrium temperature above which the aluminum alloy is completely liquid, and ends at a solidus or Scheil temperature, at which the aluminum alloy is fully solidified. The solvus temperature is the temperature at which all solid precipitates (e.g., Mg₂Si) dissolve into the aluminum alloy. The Scheil temperature is a non-equilibrium solidus temperature, based on the Scheil approximation, at which the alloy is predicted to completely solidify. The difference between the Scheil temperature (non-equilibrium) and the solidus temperature (equilibrium temperature) is referred to a solidification temperature range, which is a processing window for solution heat treatment in the completely solid state. A lower solidification temperature range is more desirable for better processability.

TABLE 11

| | Temperature (° C.) | | | |
|---|---|---|---|---|
| | Liquidus | Solidus | Scheil | Solvus |
| Example 1 | 649 | 590 | 550 | 583 |
| Example 2 | 646 | 593 | 565 | 593 |
| Example 3 | 643 | 591 | 445 | 591 |
| Example 4 | 649 | 601 | 565 | 568 |
| Example 5 | 648 | 599 | 570 | 580 |
| Example 6 | 646 | 598 | 480 | 580 |
| Example 7 | 650 | 612 | 575 | 545 |
| Example 8 | 649 | 610 | 575 | 550 |
| Example 9 | 648 | 610 | 550 | 547 |
| Comp. Ex. A | 650 | 605 | 545 | 543 |
| Comp. Ex. B | 642 | 593 | 582 | 582 |

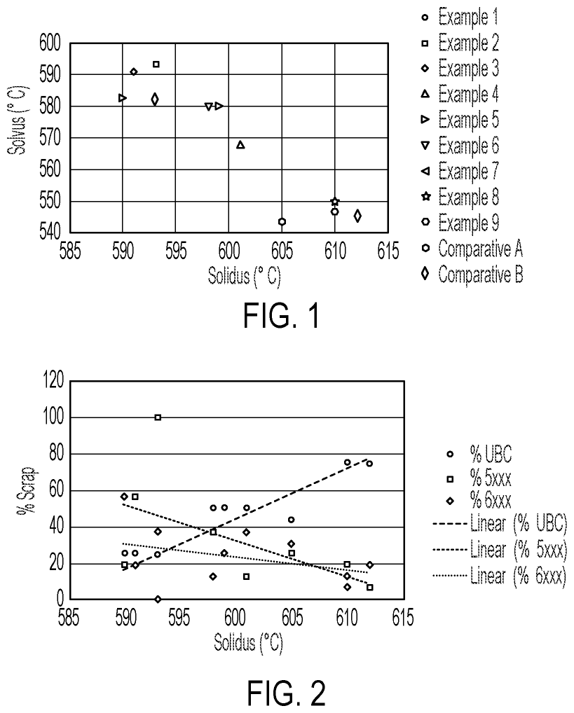

FIG. 1 shows the relationship between the solidus temperature and the amount of different recycled scrap materials used to produce the Examples Alloys 1-9 and Comparative Alloys A and B. As shown in FIG. 1, Examples 1-6 have a lower solidus temperature (e.g., 601° C. or less) than Comparative Examples A and B, thus demonstrating better processability of the example aluminum alloys. Additionally, Examples 7-9 have a solidus temperature that is comparable to Comparative Examples A and B. FIG. 2 shows the effect of the amount of recycled scrap materials on the solvus temperature and the solidus temperature. Specifically, FIG. 2 shows that the solidus temperature generally increases with higher amounts of UBC scrap, whereas the solidus temperature generally decreases with higher amounts of 5xxx series aluminum alloys and 6xxx series aluminum alloys from the mixed recycle scrap.

Table 12 provides the ratio of Si:Mg and excess Si content for Examples Alloys 1-9 and Comparative Alloys A and B. The ratio of Si:Mg and excess Si content are important parameters for achieving the mechanical properties described herein. In particular, an aluminum alloy composition having a value for Si+Mn—(Fe/2) from 0.66 to 1.00 results in a high paint bake response (e.g., Rp0.2 after paint bake at a temperature of about 185° C. for about 20 minutes and 2% pre-straining) and good elongation properties.

TABLE 12

| | Si + Mn-(Fe/2) | Si:Mg | Excess Si (wt. %) |
|---|---|---|---|
| Example 1 | 0.934 | 0.48293 | −0.31404 |
| Example 2 | 0.7965 | 0.237241 | −0.939 |
| Example 3 | 0.6585 | 0.119905 | −1.56421 |
| Example 4 | 0.963 | 0.414986 | −0.45367 |
| Example 5 | 0.872 | 0.246316 | −0.8695 |
| Example 6 | 0.7795 | 0.148777 | −1.28642 |
| Example 7 | 0.991 | 0.345508 | −0.59246 |
| Example 8 | 0.946 | 0.257846 | −0.8005 |
| Example 9 | 0.899 | 0.193514 | −1.00929 |
| Comp. Ex. A | 0.68 | 0.273973 | −0.6439 |
| Comp. Ex. B | 0.42 | 0.031546 | −1.9253 |

### Aluminum Alloy Properties

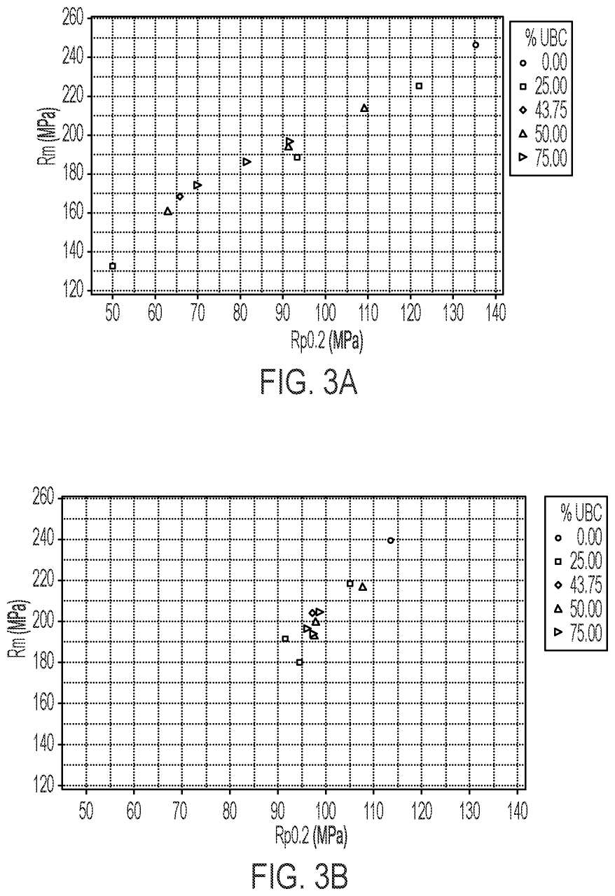

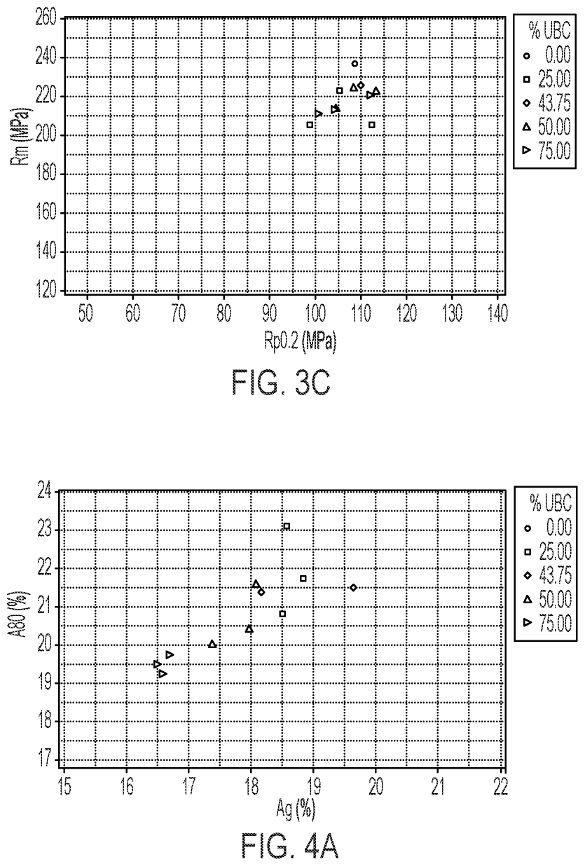

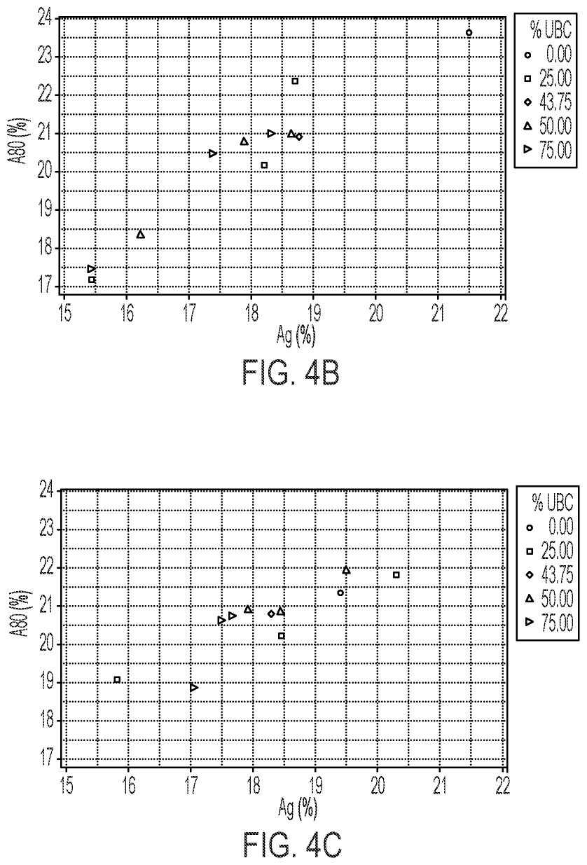

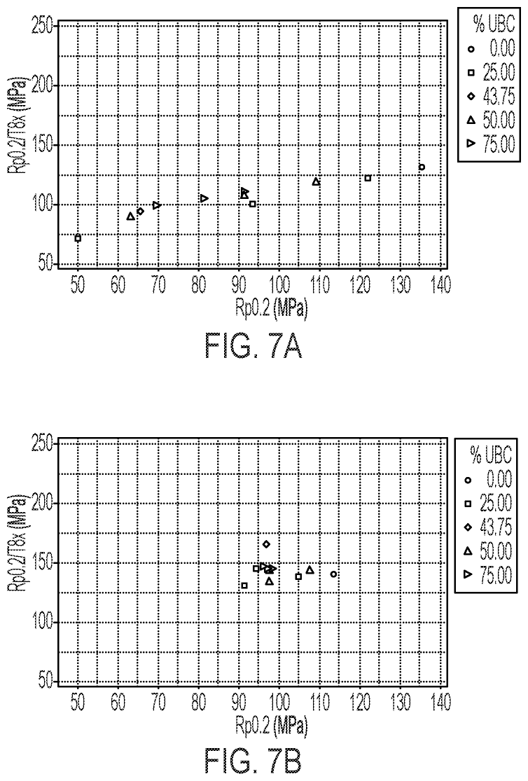

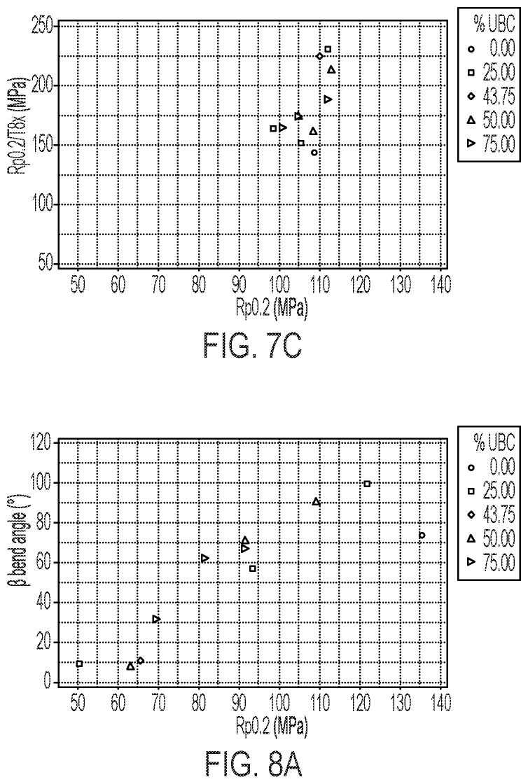

Tensile tests for Comparative Alloys A and B and Example Alloys 1-9 were performed. FIGS. 3a-c are graphs of the ultimate tensile strength (Rm) and yield strength (Rp0.2) for aluminum samples after batch annealing (e.g., after batch annealing for 2 hours at 330° C.), continuous annealing and solution heat treatment at 550° C. for 0 seconds, and continuous annealing and solution heat treatment at 550° C. for 60 seconds, respectively. As shown in FIGS. 3a-c, Example Alloys 1-9 show similar or better tensile strength than Comparative Alloys A and B. For example, FIG. 4c shows that Examples 4-6 (including about 50% UBC scrap) have a higher yield strength than Comparative Alloys A and B, and similar ultimate tensile strengths. Similarly, as shown in FIGS. 7a-7c, when Comparative Alloys A and B and Example Alloys 1-9 are artificially aged to a T8x temper, the high-recycled content alloys of Examples 1-9 still exhibit comparable yield strengths to Comparative Alloys A and B when subjected to continuous annealing and solution heat treatment.

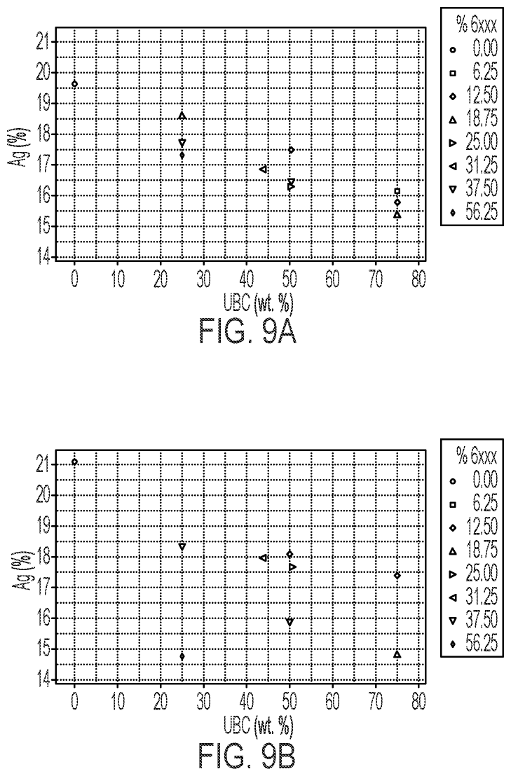

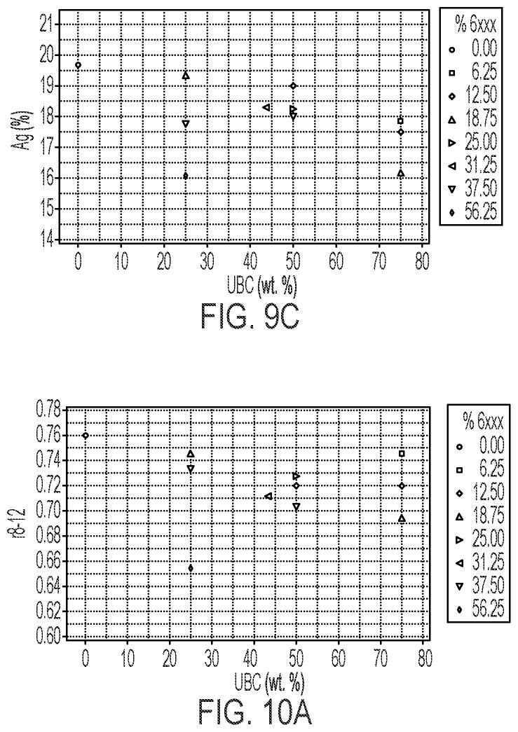

The formabilities of the samples were measured in the rolling direction using ISO/EN A80 for total elongation and ISO/EN Ag for uniform elongation. FIGS. 4a-c show the A80 and Ag for Comparative Alloys A and B and Example Alloys 1-9 after batch annealing (e.g., after batch annealing for 2 hours at 330° C.), continuous annealing and solution heat treatment at 550° C. for 0 seconds, and continuous annealing and solution heat treatment at 550° C. for 60 seconds, respectively. As shown in FIGS. 4a-4c, each of the Example Alloys 1-9 exhibited a total elongation greater than 17% and a uniform elongation greater than 15%. For samples that were batch-annealed, the total elongation and uniform elongation generally decreased with higher amounts of UBC scrap; however, FIG. 4c shows that after continuous annealing and solution heat treatment, high UBC scrap alloys (e.g., Examples 4-9) exhibited comparable total elongation and uniform elongation to Example Alloys 1-3 and Comparative Alloys A and B. FIGS. 9a-c show that the uniform elongation is greater than 15% for example alloys having about 75% UBC scrap; however, examples having higher amounts of 6xxx series aluminum alloy in the mixed alloy scrap can exhibit improved elongations when processed under tailored batch annealing conditions.

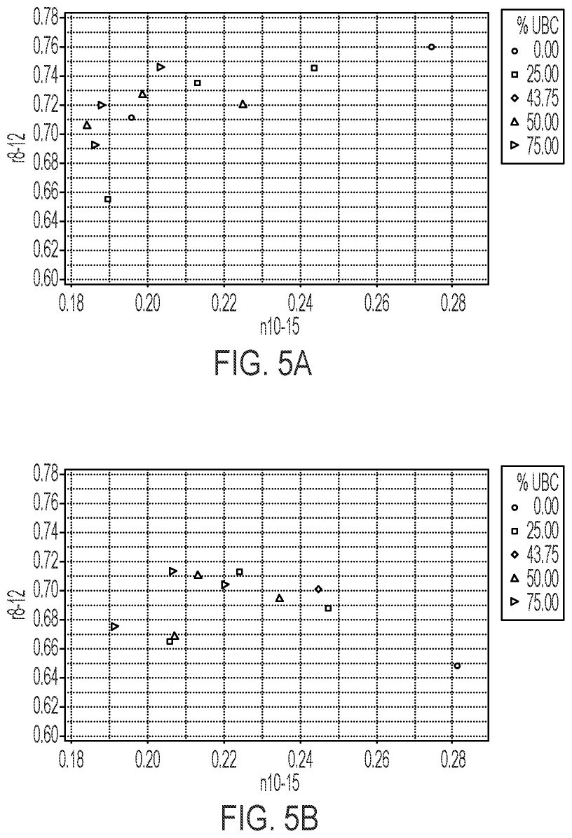

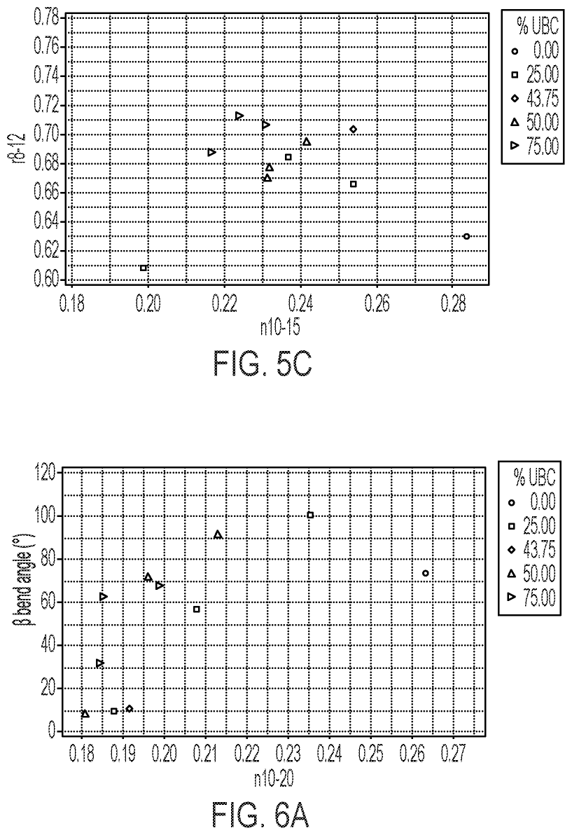

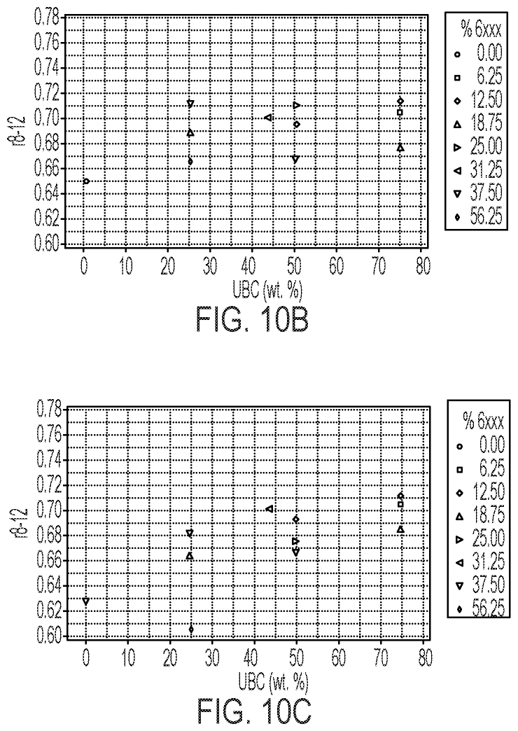

Tensile tests were also used to measure r- and n-values for the samples using ISO 10113 (2006) and ISO 10275 (2007). FIGS. 5a-c show the r- and n-values for Comparative Alloys A and B and Example Alloys 1-9 after batch annealing (e.g., after batch annealing for 2 hours at 330° C.), continuous annealing and solution heat treatment at 550° C. for 0 seconds, and continuous annealing and solution heat treatment at 550° C. for 60 seconds, respectively. As is apparent from FIGS. 5a-c, Example Alloys 1-9 show good r-values at a strain range from 8% to 12%, in excess of Comparative Alloy B. Similarly, FIG. 5c demonstrates that Example Alloys 1-8 show good r-values against Comparative Alloy A when subjected to continuous annealing and solution heat treatment at 550° C. for 60 seconds. FIGS. 10a-c show the r-values at a strain range from 8% to 12% as a function of the amount of UBC. Generally, Examples 1-9 demonstrated a higher r-value than Comparative Example B, which is unexpected considering Examples 1-9 include a high UBC scrap recycled content.

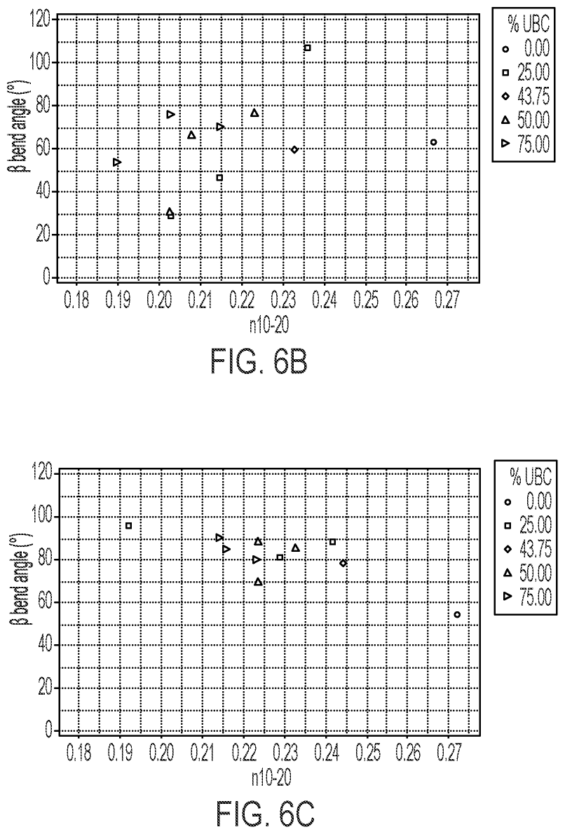

The bending properties of the samples were measured using the p bend angle according to Specification VDA 238-100, and n-values were measured at a strain range from 10% to 15% using ISO 10275 (2007). The results of these tests are shown in FIGS. 6a-c. Example Alloys 1-9 demonstrated sufficient bending comparable to Comparative Alloy B and slightly worse than Comparative Example A. Surprisingly, Example Alloys 4-9 achieved this even with their high recycling content of UBC scrap of greater than 50%.

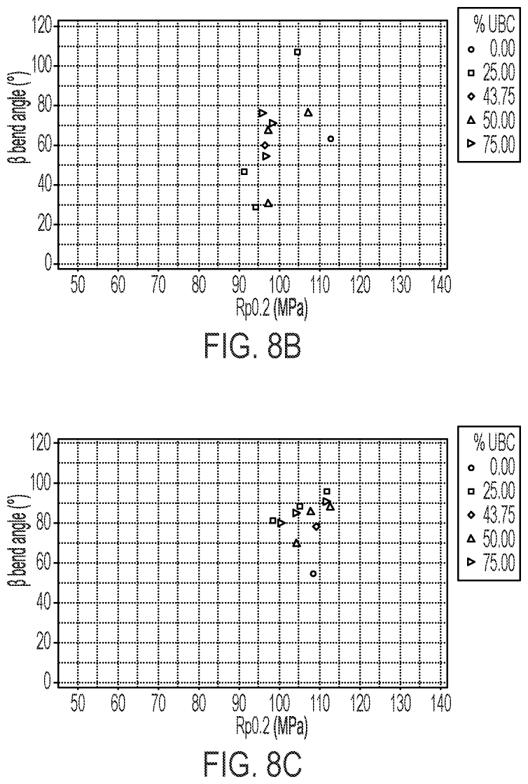

FIGS. 8a-c are graphs showing the R bend angle according to Specification VDA 238-100 and yield strength (Rp0.2) for Comparative Alloys A and B and Example Alloys 1-9 after batch annealing (e.g., after batch annealing for 2 hours at 330° C.), continuous annealing and solution heat treatment at 550° C. for 0 seconds, and continuous annealing and solution heat treatment at 550° C. for 60 seconds, respectively. As shown in FIG. 8a, the batch annealing process results in bendability and strength values for Examples 1-9 that have a large variance. However, as shown in FIGS. 8b and 8c, after a continuous annealing and solution heat treatment process, Examples 1-9 exhibited better bendability and strength values than Comparative Alloys A and B.

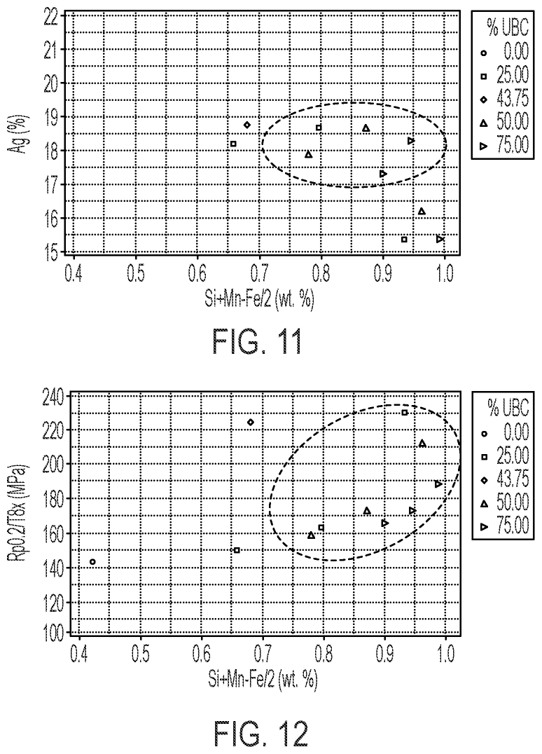

FIGS. 11 and 12 show the effects of the Si+Mn—(Fe/2) content on the elongation and strength (after paint bake) properties for Examples 1-9 and Comparative Examples A and B. Specifically, the Si+Mn—(Fe/2) content in aluminum alloy composition was investigated to determine the effects of these alloying elements on the properties of the aluminum alloys for Examples 1-9 and Comparative Examples A and B. For example, FIG. 11 is a graph of uniform elongation (Ag) (measured in %) for Examples Alloys 1-9 and Comparative Examples A and B as a function of the Si+Mn—(Fe/2) content in the aluminum alloy composition, and FIG. 12 is a graph of yield strength (Rp0.2) for Examples Alloys 1-9 and Comparative Examples A and B in a T8x temper (y-axis) (e.g., Rp0.2 after thermal treatment at a temperature of about 185° C. for about 20 minutes after 2% pre-straining) as a function of the Si+Mn—(Fe/2) content in the aluminum alloy composition. As shown in FIGS. 11 and 12, the example alloys that had a Si+Mn—(Fe/2) content from 0.70 wt. % to 1.0 wt. % (e.g., 0.75 wt. % to 0.95 wt. %) demonstrated higher strength after paint bake and also exhibited good elongation properties. For example, Example Alloy 4 exhibited excellent paint bake strength and elongation values and had a Si+Mn—(Fe/2) content from 0.70 wt. % to 1.0 wt. %. It was found for the same amount of UBC (e.g., wt. % of UBC), increasing the amount of Si+Mn-Fe/2 leads to higher paint-bake strength. For example, as shown in FIG. 12, the yield strength after thermal treatment produced aluminum alloys having higher service strength after the paint-bake cycle.

### Example 2

Aluminum Alloys from Mixed Alloy Scrap

In some embodiments, the aluminum alloys described herein can be produced from various combinations of recycled scrap. Exemplary alloy compositions prepared from various recycled scrap sources are shown below in Table 13. Example Alloys 10-44 are new formulations for aluminum alloy compositions that are produced by combining different proportions of the different recycled scrap streams. The aluminum alloys of Example Alloys 10-44 were produced by direct chill casting, hot rolling, cold rolling, and continuous annealing and solution heat treatment. Specifically, the hot rolling conditions were critical for producing the aluminum alloys of Example Alloys 10-44.

TABLE 13

| | Aluminum Alloy Compositions (wt. %) | | | | | | | |
|---|---|---|---|---|---|---|---|---|
| | Si | Mg | Cu | Fe | Mn | Cr | Zn | Zr |
| Ex. 10 | 0.75 | 0.62 | 0.22 | 0.22 | 0.15 | 0.08 | — | — |
| Ex. 11 | 0.33 | 1.13 | 0.23 | 0.16 | 0.17 | 0.04 | 0.00 | — |
| Ex. 12 | 0.62 | 1.37 | 0.25 | 0.21 | 0.18 | 0.05 | 0.04 | — |
| Ex. 13 | 0.67 | 1.41 | 0.29 | 0.20 | 0.17 | 0.07 | 0.04 | — |
| Ex. 14 | 0.57 | 1.46 | 0.35 | 0.21 | 0.17 | 0.04 | 0.60 | — |
| Ex. 15 | 0.57 | 1.43 | 0.34 | 0.21 | 0.16 | 0.04 | 0.93 | 0.012 |
| Ex. 16 | 0.44 | 2.11 | 0.16 | 0.26 | 0.19 | 0.03 | 0.02 | 0 |
| Ex. 17 | 0.33 | 1.58 | 0.12 | 0.19 | 0.14 | 0.02 | 0.02 | 0 |
| Ex. 18 | 0.37 | 1.79 | 0.13 | 0.22 | 0.16 | 0.03 | 0.02 | 0 |
| Ex. 19 | 0.38 | 1.68 | 0.14 | 0.40 | 0.55 | 0.03 | 0.08 | 0.0007 |
| Ex. 20 | 3.35 | 1.92 | 1.02 | 0.40 | 0.22 | 0.04 | 0.65 | 0 |
| Ex. 21 | 2.87 | 1.96 | 0.88 | 0.38 | 0.22 | 0.04 | 0.54 | 0 |
| Ex. 22 | 2.15 | 1.47 | 0.66 | 0.28 | 0.16 | 0.03 | 0.41 | 0 |
| Ex. 23 | 2.38 | 1.99 | 0.73 | 0.35 | 0.21 | 0.03 | 0.44 | 0 |
| Ex. 24 | 1.89 | 2.02 | 0.59 | 0.33 | 0.21 | 0.03 | 0.33 | 0 |
| Ex. 25 | 1.41 | 2.05 | 0.44 | 0.30 | 0.20 | 0.03 | 0.23 | 0 |
| Ex. 26 | 1.06 | 1.54 | 0.33 | 0.23 | 0.15 | 0.02 | 0.17 | 0 |
| Ex. 27 | 0.38 | 1.96 | 0.15 | 0.33 | 0.36 | 0.03 | 0.04 | 0.0006 |
| Ex. 28 | 0.37 | 1.93 | 0.15 | 0.35 | 0.39 | 0.03 | 0.04 | 0.0007 |
| Ex. 29 | 0.36 | 1.88 | 0.15 | 0.37 | 0.45 | 0.03 | 0.05 | 0.0009 |
| Ex. 30 | 0.76 | 2.00 | 0.23 | 0.28 | 0.25 | 0.03 | 0.15 | 0 |
| Ex. 31 | 0.57 | 1.50 | 0.17 | 0.21 | 0.19 | 0.02 | 0.11 | 0 |
| Ex. 32 | 1.08 | 1.88 | 0.30 | 0.30 | 0.31 | 0.03 | 0.28 | 0 |
| Ex. 33 | 0.81 | 1.41 | 0.23 | 0.23 | 0.23 | 0.02 | 0.21 | 0 |
| Ex. 34 | 0.59 | 1.91 | 0.16 | 0.28 | 0.30 | 0.03 | 0.17 | 0 |
| Ex. 35 | 0.75 | 1.72 | 0.16 | 0.30 | 0.41 | 0.03 | 0.32 | 0 |
| Ex. 36 | 0.56 | 1.29 | 0.12 | 0.23 | 0.31 | 0.02 | 0.24 | 0 |
| Ex. 37 | 0.90 | 1.52 | 0.17 | 0.33 | 0.53 | 0.03 | 0.47 | 0 |
| Ex. 38 | 0.68 | 1.14 | 0.13 | 0.25 | 0.39 | 0.03 | 0.35 | 0 |
| Ex. 39 | 1.36 | 1.90 | 0.44 | 0.38 | 0.37 | 0.03 | 0.25 | 0.0006 |
| Ex. 40 | 1.13 | 1.96 | 0.37 | 0.34 | 0.31 | 0.03 | 0.19 | 0.0004 |
| Ex. 41 | 0.70 | 1.57 | 0.16 | 0.38 | 0.58 | 0.03 | 0.34 | 0.0006 |
| Ex. 42 | 0.87 | 1.42 | 0.17 | 0.38 | 0.64 | 0.03 | 0.48 | 0.0004 |
| Ex. 43 | 0.71 | 1.62 | 0.16 | 0.36 | 0.53 | 0.03 | 0.33 | 0.0004 |
| Ex. 44 | 0.53 | 1.21 | 0.12 | 0.27 | 0.40 | 0.02 | 0.25 | 0.0003 |

In Table 13, all values are in weight percent (wt. 0%) of the whole. The alloys can contain up to 0.15 wt. 0% total impurities and the remainder is aluminum. The aluminum alloys of Examples 10-44 were produced from different mixed alloy scrap materials. In particular, Examples 10-15 were produced from recycled scrap derived from EOL aluminum-intensive vehicle (e.g., mixed 5xxx series, 6xxx series, and 7xxx series aluminum alloy from wrought and cast aluminum alloys, extruded aluminums, etc.), Example 16 was produced from mixed automotive scrap, Examples 17 and 18 were produced from mixed automotive scrap and primary aluminum alloy, Example 19 was produced from UBC scrap, mixed automotive scrap, and segregated automotive scrap, Examples 20-26 were produced from twitch and mixed automotive scrap, Examples 27-29 were produced from UBC scrap and mixed automotive scrap, Examples 30-33 were produced from UBC scrap, mixed automotive scrap, and braze alloy scrap, Examples 34-38 were produced from mixed automotive scrap and braze alloy scrap, Examples 39 and 40 were produced from UBC scrap, mixed automotive scrap, and twitch, Examples 41-44 were produced from braze alloy scrap, mixed automotive scrap, and twitch.

### Example 3

Aluminum alloy samples 45-49 were produced according to the process described in Example 1. Table 14 provides the recycled scrap content and types of recycled scrap in Examples 45-49. Example Alloy 45 included 50 wt. % UBC scrap and 50 wt. % mixed alloy scrap, Example Alloy 46 included 75 wt. % UBC scrap and 25 wt. % mixed alloy scrap, Example Alloy 47 included 100 wt. % UBC scrap, Example 48 included 25 wt. % UBC scrap, 50 wt. % mixed alloy scrap, and 25 wt. % random scrap (e.g., non-automotive scrap), and Example 49 included 90 wt. % can body stock (CBS) and 5-10 wt. % prime aluminum alloy.

TABLE 14

| | Recycled Content (wt. %) | | | | | |
|---|---|---|---|---|---|---|
| | | | Mixed Alloy Scrap | | | |
| | | | | 5xxx | 6xxx | |
| | CBS | UBC | Type of Mixed | Series | Series | Random |
| Element | Scrap | Scrap | Alloy Scrap | Scrap | Scrap | Scrap |
| Example 45 | — | 50 | 5xxx in 6xxx | 12.5 | 37.5 | |
| Example 46 | — | 75 | 6xxx in 5xxx | 18.75 | 6.25 | |
| Example 47 | — | 100 | — | — | — | |
| Example 48 | — | 25 | 5xxx in 6xxx | 25 | 25 | 25 |
| Example 49 | 90 | — | — | — | — | — |

The aluminum alloy compositions for Examples Alloys 45-49 are shown in Table 15. In Table 15, all values are in weight percent (wt. %) of the whole. The alloys can contain up to 0.15 wt. % total impurities and the remainder is aluminum.

TABLE 15

| | Aluminum Alloy Compositions (wt. %) | | | | | | | | |
|---|---|---|---|---|---|---|---|---|---|
| | Si | Mg | Fe | Cu | Mn | Cr | Ti | V | Zn |
| Example 45 | 0.46 | 1.85 | 0.29 | 0.36 | 0.53 | 0.029 | 0.01 | 0.011 | 0.023 |
| Example 46 | 0.35 | 1.91 | 0.34 | 0.35 | 0.66 | 0.015 | 0.01 | 0.01 | 0.021 |
| Example 47 | 0.21 | 1.39 | 0.51 | 0.17 | 0.78 | 0.017 | 0.06 | 0.01 | 0.02 |
| Example 48 | 0.46 | 1.54 | 0.39 | 0.24 | 0.41 | 0.052 | 0.012 | 0.012 | 0.018 |
| Example 49 | 0.25 | 1.1 | 0.54 | 0.18 | 0.85 | 0.02 | 0.075 | 0.01 | 0.02 |

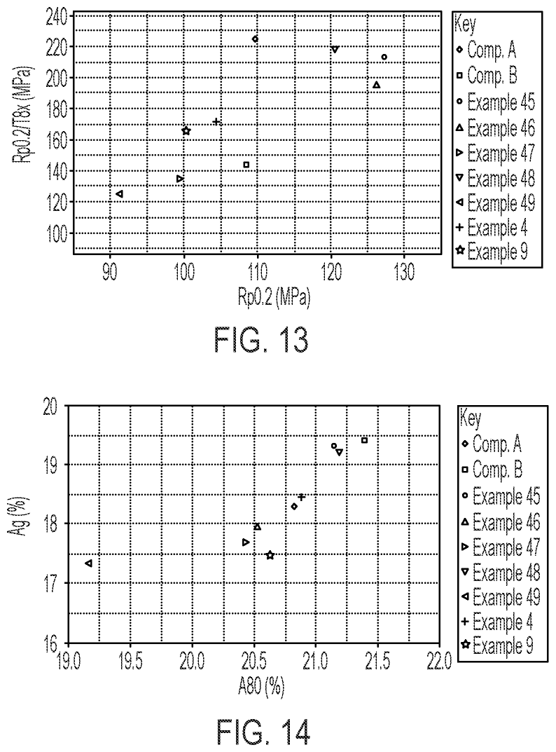

The aluminum alloy compositions for Examples Alloys 45 and 49 have a similar composition as Examples 4 and 9, respectively, but have a higher content of Cu. The additional Cu in Examples 45 and 46 increased the strength of the aluminum alloy. For example, FIG. 13 shows that the addition of Cu leads to higher yield strength in the T4 temper and the T8x temper (e.g., Rp0.2 after thermal treatment at a temperature of about 185° C. for about 20 minutes after 2% pre-straining). In fact, Examples 45, 46, and 48 had a higher strength values than Comparative Examples A and B, which were not produced from mixed alloy scrap. Thus, Examples 45, 46, and 48 can attain higher strength values while incorporating recycled scrap from multiple different scrap systems. Additionally, Examples 45, 46, and 48 had a paint bake response comparable to Comparative Example A. Examples 47 and 49, which were produced primarily from UBS or UBC, had significantly lower strength values.

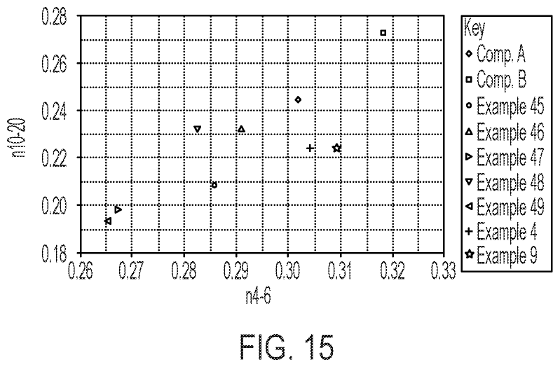

FIGS. 14 and 15 show the elongation and n-values of Examples 45-49 compared to Comparative Examples A and B. Comparative Example B had the highest total elongation and uniform elongation; however, Examples 45 and 48 exhibited comparable elongation values. Overall, Example 48 exhibited the best combination of properties. Thus, depending on which target properties are desired (e.g., high strength, elongation, etc.), alloying elements can be added to the aluminum alloys produced from recycled scrap to achieve these properties. For example, as demonstrated by Example Alloys 45 and 46, additional amounts of Cu can be added to the aluminum alloy composition for higher strength and elongation.

### Illustrations

Illustration 1 is an aluminum alloy, comprising 0.50 wt. %-3.00 wt. % Mg, 0.10 wt. %-3.50 wt. % Si, 0.01 wt. %-0.60 wt. % Fe, up to 1.20 wt. % Cu, 0.10 wt. %-0.90 wt. % Mn, up to 0.20 wt. % Cr, up to 0.20 wt. % Ti, up to 0.10 wt. % V, up to 1.00 wt. % Zn, up to 0.15 wt. % impurities, and Al.

Illustration 2 is the aluminum alloy of any preceding or subsequent illustration, comprising 1.00 wt. %-2.50 wt. % Mg, 0.20 wt. %-3.00 wt. % Si, 0.15 wt. %-0.50 wt. % Fe, 0.001 wt. %-0.90 wt. % wt. % Cu, 0.20 wt. %-0.80 wt. % Mn, up to 0.15 wt. % Cr, up to 0.10 wt. % Ti, up to 0.08 wt. % V, 0.001 wt. %-0.50 wt. % Zn, up to 0.15 wt. % impurities, and Al.

Illustration 3 is the aluminum alloy of any preceding or subsequent illustration, comprising 1.40 wt. %-2.40 wt. % Mg, 0.30 wt. %-2.50 wt. % Si, 0.20 wt. %-0.40 wt. % Fe, 0.05 wt. %-0.75 wt. % Cu, 0.40 wt. %-0.70 wt. % Mn, up to 0.10 wt. % Cr, up to 0.05 wt. % Ti, up to 0.05 wt. % V, 0.005 wt. %-0.40 wt. % Zn, up to 0.15 wt. % impurities, and Al.

Illustration 4 is the aluminum alloy of any preceding or subsequent illustration, comprising 1.00 wt. %-3.00 wt. % Mg, 0.10 wt. %-0.90 wt. % Si, 0.01 wt. %-0.60 wt. % Fe, up to 0.50 wt. % Cu, 0.10 wt. %-0.90 wt. % Mn, up to 0.20 wt. % Cr, up to 0.20 wt. % Ti, up to 0.10 wt. % V, up to 1.00 wt. % Zn, up to 0.15 wt. % impurities, and Al; wherein the aluminum alloy comprises up to 100% recycled scrap; and wherein the recycled scrap comprises at least 25% of used beverage can scrap, based on the total weight of the recycled scrap.

Illustration 5 is the aluminum alloy of any preceding or subsequent illustration, comprising 1.25 wt. %-2.50 wt. % Mg, 0.20 wt. %-0.80 wt. % Si, 0.15 wt. %-0.50 wt. % Fe, 0.01 wt. %-0.30 wt. % Cu, 0.20 wt. %-0.80 wt. % Mn, up to 0.15 wt. % Cr, up to 0.10 wt. % Ti, up to 0.05 wt. % V, up to 0.50 wt. % Zn, up to 0.15 wt. % impurities, and Al.

Illustration 6 is the aluminum alloy of any preceding or subsequent illustration, comprising 1.60 wt. %-2.40 wt. % Mg, 0.30 wt. %-0.60 wt. % Si, 0.20 wt. %-0.40 wt. % Fe, 0.05 wt. %-0.20 wt. % Cu, 0.40 wt. %-0.70 wt. % Mn, up to 0.10 wt. % Cr, up to 0.05 wt. % Ti, up to 0.03 wt. % V, up to 0.20 wt. % Zn, up to 0.15 wt. % impurities, and Al.

Illustration 7 is the aluminum alloy of any preceding or subsequent illustration, wherein a ratio of the wt. % of Si:Mg is from 0.05:1 to 0.60:1.

Illustration 8 is the aluminum alloy of any preceding or subsequent illustration, wherein the aluminum alloy has an excess Si content from −1.70 to 0.10.

Illustration 9 is the aluminum alloy of any preceding or subsequent illustration, wherein the aluminum alloy comprises a Cu content of less than 0.20 wt. %, a Si:Mg ratio from 0.20:1 to 0.45:1, and an excess Si content from −1.30 to 0.

Illustration 10 is the aluminum alloy of any preceding or subsequent illustration, wherein the recycled scrap comprises at least 50% of used beverage can scrap, based on the total weight of the recycled scrap.

Illustration 11 is the aluminum alloy of any preceding or subsequent illustration, wherein the recycled scrap comprises at least 25% of mixed alloy scrap.

Illustration 12 is the aluminum alloy of any preceding or subsequent illustration, wherein the mixed alloy scrap comprises one or more of a 5xxx series aluminum alloy, a 6xxx series aluminum alloy, and a 7xxx series aluminum alloy.

Illustration 13 is the aluminum alloy of any preceding or subsequent illustration, wherein the mixed alloy scrap comprises a ratio of the 5xxx series aluminum alloy to the 6xxx series aluminum alloy from 1:3 to 3:1.

Illustration 14 is the aluminum alloy of any preceding or subsequent illustration, wherein the mixed alloy scrap comprises at least 18.75 wt. % of the 5xxx series aluminum alloy, based on the total weight of the recycled scrap.

Illustration 15 is the aluminum alloy of any preceding or subsequent illustration, wherein the mixed alloy scrap comprises at least 18.75 wt. % of 6xxx series aluminum alloy, based on the total weight of the recycled scrap.

Illustration 16 is the aluminum alloy of any preceding or subsequent illustration, wherein the aluminum alloy, when in a T4 temper, has a yield strength (Rp0.2) of from 160 MPa to 250 MPa when tested according to ISO 6892-1 (2016) after paint baking at a temperature of about 185° C. for about 20 minutes and 2% pre-straining.

Illustration 17 is the aluminum alloy of any preceding or subsequent illustration, wherein the aluminum alloy has a total elongation of at least 15%.

Illustration 18 is the aluminum alloy of any preceding or subsequent illustration, wherein the aluminum alloy has a r(10) value of at least 0.40 in all directions (longitudinal (L), diagonal (D), and/or transverse (T) to a rolling direction).

Illustration 19 is the aluminum alloy of any preceding or subsequent illustration, wherein the aluminum alloy has a R bend angle of from 40° to 100° for bendability testing according to Specification VDA 238-100.

Illustration 20 is the aluminum alloy of any preceding or subsequent illustration, wherein the aluminum alloy excludes any primary aluminum alloy.

Illustration 21 is the aluminum alloy of any preceding or subsequent illustration, wherein the aluminum alloy is a sheet, a plate, an electronic device housing, an automotive structural part, an aerospace structural part, an aerospace non-structural part, a marine structural part, or a marine non-structural part.

Illustration 22 is the aluminum alloy of any preceding or subsequent illustration, wherein the aluminum alloy is produced from a process comprising homogenization, hot rolling, cold rolling, solution heat treatment, pre-aging, and artificial aging.

Illustration 23 is the aluminum alloy of any preceding or subsequent illustration, wherein the aluminum alloy is cool coiled after hot rolling.

Illustration 24 is the aluminum alloy of any preceding or subsequent illustration, wherein the aluminum alloy comprises at least 75% recycled scrap.

Illustration 25 is the aluminum alloy of any preceding or subsequent illustration, wherein the aluminum alloy comprises recycled scrap from one or more of end-of life aluminum articles, mixed automotive scrap, UBC scrap, twitch, and heat exchanger scrap.

Illustration 26 is the aluminum alloy of any preceding or subsequent illustration, wherein the recycled scrap comprises the end-of life aluminum articles and wherein the end-of life aluminum articles are derived from aluminum-intensive vehicles.

Illustration 27 is the aluminum alloy of any preceding or subsequent illustration, wherein the recycled scrap comprises 100% of scrap derived from the end-of life aluminum articles.

Illustration 28 is the aluminum alloy of any preceding or subsequent illustration, wherein the recycled scrap comprises the heat exchanger scrap and wherein the heat exchanger scrap comprises braze alloy scrap.

Illustration 29 is the aluminum alloy of any preceding or subsequent illustration, wherein the recycle scrap comprises the mixed automotive scrap and the mixed automotive scrap comprises recycled scrap from wrought alloys and cast alloys.

Illustration 30 is the aluminum alloy of any preceding or subsequent illustration, wherein the aluminum alloy comprises up to 25% primary aluminum alloy.

All patents, publications and abstracts cited above are incorporated herein by reference in their entirety. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the present invention as defined in the following claims.

1. An aluminum alloy, comprising 0.50 wt. %-3.00 wt. % Mg, 0.10 wt. %-3.50 wt. % Si, 0.01 wt. %-0.60 wt. % Fe, up to 1.20 wt. % Cu, 0.10 wt. %-0.90 wt. % Mn, up to 0.20 wt. % Cr, up to 0.20 wt. % Ti, up to 0.10 wt. % V, up to 1.00 wt. % Zn, up to 0.15 wt. % impurities, and Al.

2. The aluminum alloy of claim 1, comprising 1.00 wt. %-2.50 wt. % Mg, 0.20 wt. %-3.00 wt. % Si, 0.15 wt. %-0.50 wt. % Fe, 0.001 wt. %-0.90 wt. % wt. % Cu, 0.20 wt. %-0.80 wt. % Mn, up to 0.15 wt. % Cr, up to 0.10 wt. % Ti, up to 0.08 wt. % V, 0.001 wt. %-0.50 wt. % Zn, up to 0.15 wt. % impurities, and Al.

3. The aluminum alloy of claim 1, comprising 1.40 wt. %-2.40 wt. % Mg, 0.30 wt. %-2.50 wt. % Si, 0.20 wt. %-0.40 wt. % Fe, 0.05 wt. %-0.75 wt. % Cu, 0.40 wt. %-0.70 wt. % Mn, up to 0.10 wt. % Cr, up to 0.05 wt. % Ti, up to 0.05 wt. % V, 0.005 wt. %-0.40 wt. % Zn, up to 0.15 wt. % impurities, and Al.

4. The aluminum alloy of claim 1, comprising 1.00 wt. %-3.00 wt. % Mg, 0.10 wt. %-0.90 wt. % Si, 0.01 wt. %-0.60 wt. % Fe, up to 0.50 wt. % Cu, 0.10 wt. %-0.90 wt. % Mn, up to 0.20 wt. % Cr, up to 0.20 wt. % Ti, up to 0.10 wt. % V, up to 1.00 wt. % Zn, up to 0.15 wt. % impurities, and Al;
wherein the aluminum alloy comprises up to 100% recycled scrap; and
wherein the recycled scrap comprises at least 25% of used beverage can scrap, based on the total weight of the recycled scrap.

5. The aluminum alloy of claim 1, comprising 1.25 wt. %-2.50 wt. % Mg, 0.20 wt. %-0.80 wt. % Si, 0.15 wt. %-0.50 wt. % Fe, 0.01 wt. %-0.30 wt. % Cu, 0.20 wt. %-0.80 wt. % Mn, up to 0.15 wt. % Cr, up to 0.10 wt. % Ti, up to 0.05 wt. % V, up to 0.50 wt. % Zn, up to 0.15 wt. % impurities, and Al.

6. The aluminum alloy of claim 1, comprising 1.60 wt. %-2.40 wt. % Mg, 0.30 wt. %-0.60 wt. % Si, 0.20 wt. %-0.40 wt. % Fe, 0.05 wt. %-0.20 wt. % Cu, 0.40 wt. %-0.70 wt. % Mn, up to 0.10 wt. % Cr, up to 0.05 wt. % Ti, up to 0.03 wt. % V, up to 0.20 wt. % Zn, up to 0.15 wt. % impurities, and Al.

7. The aluminum alloy of claim 1, wherein a ratio of the wt. % of Si:Mg is from 0.05:1 to 0.60:1.

8. The aluminum alloy of claim 1, wherein the aluminum alloy has an excess Si content from −1.70 to 0.10.

9. The aluminum alloy of claim 1, wherein the aluminum alloy comprises a Cu content of less than 0.20 wt. %, a Si:Mg ratio from 0.20:1 to 0.45:1, and an excess Si content from −1.30 to 0.

10. The aluminum alloy of claim 1, wherein the aluminum alloy comprises up to 100% recycled scrap, and wherein the recycled scrap comprises at least 50% of used beverage can scrap, based on the total weight of the recycled scrap.

11. The aluminum alloy of claim 10, wherein the recycled scrap comprises at least 25% of mixed alloy scrap.

12. The aluminum alloy of claim 11, wherein the mixed alloy scrap comprises one or more of a 5xxx series aluminum alloy, a 6xxx series aluminum alloy, and a 7xxx series aluminum alloy.

13. The aluminum alloy of claim 12, wherein the mixed alloy scrap comprises a ratio of the 5xxx series aluminum alloy to the 6xxx series aluminum alloy from 1:3 to 3:1.

14. (canceled)

15. (canceled)

16. The aluminum alloy of claim 1, wherein the aluminum alloy, when in a T4 temper, has a yield strength (Rp0.2) of from 160 MPa to 250 MPa when tested according to ISO 6892-1 (2016) after paint baking at a temperature of 185° C. for 20 minutes and 2% pre-straining.

17. The aluminum alloy of claim 1, wherein the aluminum alloy has a total elongation of at least 15%, wherein the aluminum alloy has a r(10) value of at least 0.40 in all directions (longitudinal (L), diagonal (D), and/or transverse (T) to a rolling direction), wherein the aluminum alloy has a 3 bend angle of from 40° to 100° for bendability testing according to Specification VDA 238-100.

18. (canceled)

19. (canceled)

20. The aluminum alloy of claim 1, wherein the aluminum alloy excludes any primary aluminum alloy.

21. The aluminum alloy of claim 1, wherein the aluminum alloy is a sheet, a plate, an electronic device housing, an automotive structural part, an aerospace structural part, an aerospace non-structural part, a marine structural part, or a marine non-structural part.

22. The aluminum alloy of claim 1, wherein the aluminum alloy is produced from a process comprising homogenization, hot rolling, cold rolling, solution heat treatment, pre-aging, and artificial aging.

23. (canceled)

24. (canceled)

25. The aluminum alloy of claim 1, wherein the aluminum alloy comprises recycled scrap from one or more of end-of life aluminum articles, mixed automotive scrap, UBC scrap, twitch, and heat exchanger scrap.

26. (canceled)

27. The aluminum alloy of claim 25, wherein the recycled scrap comprises 100% of scrap derived from the end-of life aluminum articles.

28. (canceled)

29. (canceled)

30. (canceled)
